(19) United States
(12) Patent Application Publication
(10) Pub. No.: US 2026/0248341 A1
(43) Pub. Date: Aug. 27, 2026

(54) ROBOT CLEANER STATION

(71) Applicant: LG ELECTRONICS INC., Seoul (KR)

(72) Inventors: Ingyu Yang, Seoul (KR); Daeho Chang, Seoul (KR); Donggeun Lee, Seoul (KR)

(73) Assignee: LG ELECTRONICS INC., Seoul (KR)

(21) Appl. No.: 19/549,809

(22) Filed: Feb. 25, 2026

(30) Foreign Application Priority Data
Feb. 26, 2025 (KR) 10-2025-0025332

(51) Int. Cl. A47L 11/40

(52) U.S. Cl. CPC A47L 11/4091; A47L 2201/028

(57) ABSTRACT

Embodiments of the present disclosure relate to a robot cleaner station. The robot cleaner station includes: a housing having an entrance through which a robot cleaner enters and exits; a base accommodated inside the housing and disposed below the robot cleaner; an accommodation space formed between the base and an upper cover of the housing to accommodate the robot cleaner; and a mop drying unit configured to dry a mop of the robot cleaner. The mop drying unit includes a blower fan configured to provide a flow force to air discharged into the accommodation space. The blower fan is disposed in the housing such that a surface from which air is discharged faces the accommodation space, and an imaginary axis extending from a rotation shaft of the blower fan forms a predetermined inclination with respect to the ground. Through this configuration, an air flow within the housing is smoothly established, and operational stability is enhanced by preventing overheating of the blower fan.

This application claims priority to and the benefit of Korean Patent Application No. 10-2025-0025332 filed on Feb. 26. 2025, the disclosure of which is incorporated herein by reference in its entirety.

### BACKGROUND

### Technical Field

Embodiments of the present disclosure relate to a station for a robot cleaner, and more particularly, to a built-in docking station for a robot cleaner configured to, upon docking of the robot cleaner, perform dust collection from a dustbin of the robot cleaner, wash a mop of the robot cleaner, and dry the mop.

### Background of the Disclosure

With the recent advancements in industrial technology, robot cleaners have been developed to autonomously navigate and clean designated areas without user intervention.

Such robot cleaners are equipped with sensors for space recognition, agitators for sweeping floor surfaces, and mops for wiping floor surfaces. These cleaners are configured to navigate while suctioning dust and wiping the floor surfaces based on the spatial data acquired by the sensors.

Among robot cleaners, there are dry-type robot cleaners designed to remove scattered debris through suction and wet-type robot cleaners configured to wipe the floor with moistened mops to effectively remove adhered contaminants. Dry-type robot cleaners include a dust bin and utilize the suction force of a vacuum motor. Wet-type robot cleaners include a water tank, where water is supplied to the mop to maintain moisture for effective cleaning. Furthermore, some robot cleaners are equipped with both an agitator and a mop.

A charging dock for a robot cleaner is a device to which the robot cleaner docks after completing a cleaning task to supply power to an onboard battery. The charging dock includes a power supply module and charging terminals connected thereto, while the robot cleaner includes corresponding terminals. Power is supplied to the battery upon contact between the charging terminals and the corresponding terminals.

However, when a robot cleaner charging dock is disposed within an indoor space, it occupies a certain amount of floor area, which may degrade space efficiency. In addition, collisions between the robot cleaner and users or pets during movement can lead to personal injury or damage to the robot cleaner.

Furthermore, in the case of stations integrated with dust collection functions for robot cleaners, the increased volume may detract from the interior aesthetics of the indoor environment.

Meanwhile, Chinese Utility Model Registration No. CN 218922468 U discloses a station for a robot cleaner coupled to a lower portion of a washing machine to perform charging, dust collection, and mop washing for the robot cleaner.

The aforementioned station is configured to supply drying air to a washing tub where the mop is washed, thereby drying the mop positioned at an upper side of the washing tub.

However, when the mop is dried in an open indoor space as in the aforementioned station, the indoor humidity may increase due to water vapor generated during the drying process. Furthermore, as wastewater generated during the mop washing process evaporates during drying, malodors may propagate into the indoor environment.

In addition, since heated air disperses into the external environment during the drying process in an open space, the heated air must be continuously supplied for an extended period, leading to a limitation of reduced energy efficiency.

Moreover, the aforementioned station requires an increased number of components due to a complex flow path structure, and inadequate airflow may result in issues such as heater overheating and degraded safety.

### SUMMARY

Embodiments of the present disclosure have been conceived to address the aforementioned problems of conventional robot cleaner stations. Embodiments of the present disclosure provide a robot cleaner station configured to be built into a lower portion of a kitchen cabinet without requiring a separate installation space.

Embodiments of the present disclosure provide a robot cleaner station capable of accommodating a robot cleaner within a space below a kitchen cabinet having a predetermined height restriction.

Embodiments of the present disclosure further provide a robot cleaner station configured to automatically collect dust from a dust bin of a robot cleaner upon docking.

Embodiments of the present disclosure may also provide a simplified flow path configuration to reduce the number of components and maximize space utilization within a housing.

Embodiments of the present disclosure provide a robot cleaner station configured to facilitate smooth airflow by optimizing a clearance between a blower fan and a rear surface, thereby ensuring operational stability by preventing heater overheating.

To achieve the aforementioned objects, a robot cleaner station according to an embodiment of the present disclosure includes: a housing including an upper cover; a base accommodated inside the housing and disposed below a robot cleaner; an accommodation space formed between the base and the upper cover, wherein at least a portion of the robot cleaner is accommodated in the accommodation space; and a mop drying unit configured to dry a mop of the robot cleaner. The mop drying unit includes a blower fan configured to provide a flow force to air discharged into the accommodation space. The blower fan is disposed in the housing such that a surface from which air is discharged faces the accommodation space, and an imaginary axis extending from a rotation shaft of the blower fan may form a predetermined inclination with respect to the ground.

Further, the housing includes: an entrance through which the robot cleaner enters and exits; and a rear surface disposed in a direction opposite to the entrance, wherein at least a portion of the blower fan may be spaced apart from the rear surface.

Meanwhile, the mop drying unit may include a heater disposed forward of the blower fan and configured to heat air, and the blower fan axis may penetrate the heater.

In addition, the mop drying unit may include an air discharge portion disposed forward of the heater and having an air discharge port formed therein to discharge heated air toward the accommodation space, wherein the air discharge portion may be inclined downward as a distance from the heater increases.

Meanwhile, a pair of the air discharge portions may be formed symmetrically in a left-right direction with respect to the blower fan axis.

Further, the mop drying unit may include an air supply flow path connecting air introduced into the housing to the accommodation space, and the air supply flow path may be branched toward both sides with respect to the blower fan axis and connected to the accommodation space.

In addition, a virtual plane including the blower fan axis and a virtual line connecting left and right points forming a maximum width of the blower fan may penetrate the air discharge port.

Meanwhile, the mop drying unit includes an air supply flow path connecting an outside of the housing to the accommodation space, the blower fan and the heater being disposed inside the air supply flow path, and a height of the air supply flow path may decrease from the blower fan toward the heater.

Further, the mop drying unit may include an air discharge portion configured to discharge air within the accommodation space to an outside. The air discharge portion may include: an air intake communicating with the accommodation space to suction air; and an exhaust fan configured to cause the air within the accommodation space to flow toward the air intake. The exhaust fan may be disposed such that a virtual exhaust fan axis extending from a rotation shaft of the exhaust fan is perpendicular to the ground.

Meanwhile, the exhaust fan may be disposed above a path along which the robot cleaner moves within the housing.

Further, the exhaust fan may be disposed on the upper cover.

Meanwhile, the mop drying unit may include: a heater disposed forward of the blower fan and configured to heat air; and an air discharge port disposed forward of the heater and configured to discharge heated air toward the accommodation space, wherein the air intake may be disposed at a position higher than the air discharge port relative to the ground than the air discharge port.

Further, a distance from the air discharge port to the air intake may be greater than a distance from the air discharge port to the mop.

Meanwhile, a distance between an uppermost end of the blower fan and the rear surface may be greater than a distance between a lowermost end of the blower fan and the rear surface.

In addition, a maximum distance between the blower fan and the rear surface may be 25 mm or more and 35 mm or less.

According to embodiments of the present disclosure, modules for charging the robot cleaner, collecting dust, and washing a mop are arranged along a horizontal direction with respect to the robot cleaner. This configuration enables efficient utilization of the space beneath a kitchen cabinet.

In addition, charging terminals, a dust collection unit, a mop washing unit, and a mop drying unit are disposed to surround the robot cleaner, thereby allowing multiple functions to be performed simultaneously for the robot cleaner.

Furthermore, since the surfaces of the station—excluding the front surface—are concealed by the kitchen cabinet, the station may enhance interior aesthetics for the user.

Additionally, a blower fan is disposed at an inclined angle, which improves space utilization and simplifies a flow path configuration, thereby reducing the number of components.

Moreover, by optimizing a clearance between the blower fan and a rear surface, a smooth airflow is established, and heater overheating is prevented, leading to enhanced operational stability.

### [BRIEF DESCRIPTION OF DRAWINGS]

FIG. 1 is a view for explaining a state in which a cleaner system is installed at a lower portion of a kitchen cabinet, according to an embodiment of the present disclosure.

FIG. 2 is a view for explaining a relationship in which piping of a cleaner system is connected to a drain pipe, according to an embodiment of the present disclosure.

FIG. 3 is a perspective view for explaining a cleaner system according to an embodiment of the present disclosure.

FIG. 4 is a plan view of FIG. 3.

FIG. 5 is a perspective view for explaining a robot cleaner according to an embodiment of the present disclosure.

FIG. 6 is a side view of FIG. 5.

FIG. 7 is a bottom view of FIG. 5.

FIG. 8 is a rear view of FIG. 5.

FIG. 9 is a perspective view for explaining a structure of a robot cleaner station according to an embodiment of the present disclosure.

FIG. 10 is a perspective view for explaining a door unit of a robot cleaner station according to an embodiment of the present disclosure.

FIG. 11 is a perspective view for explaining an internal structure of a robot cleaner station according to an embodiment of the present disclosure.

FIG. 12 is a plan view for explaining a mop drying unit of a robot cleaner station according to an embodiment of the present disclosure.

FIG. 13 is a cross-sectional view taken along line A-A of FIG. 12.

FIG. 14 is a cross-sectional view taken along line B-B of FIG. 12.

FIG. 15 is a block diagram for explaining a control configuration in a robot cleaner station according to an embodiment of the present disclosure.

### DETAILED DESCRIPTION OF SPECIFIC EMBODIMENTS

Hereinafter, embodiments according to the present disclosure will be described with reference to the accompanying drawings.

While the present disclosure is susceptible to various modifications and alternative forms, specific embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure.

In describing the present disclosure, terms such as “first,” “second,” and the like may be used to describe various components, but these components should not be limited by these terms. These terms are only used to distinguish one component from another. For example, a first component could be termed a second component, and similarly, a second component could be termed a first component, without departing from the scope of the present disclosure.

The term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

The terminology used herein is for the purpose of describing particular embodiments only and is not intended to be limiting of the present disclosure. As used herein, the singular forms are intended to include the plural forms as well, unless the context clearly indicates otherwise.

In the present disclosure, it will be further understood that the terms “comprises,” “comprising,” “includes,” and/or “including,” when used herein, specify the presence of stated features, integers, steps, operations, elements, components, and/or groups thereof, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Furthermore, the following embodiments are provided to more completely explain the present disclosure to those skilled in the art, and the shapes and sizes of elements in the drawings may be exaggerated for clarity of description.

### Kitchen Cabinet and Cleaner System

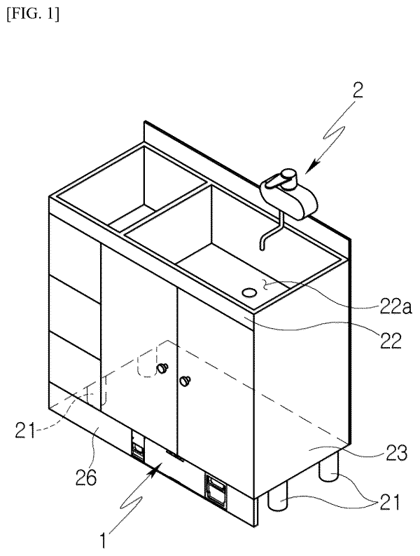

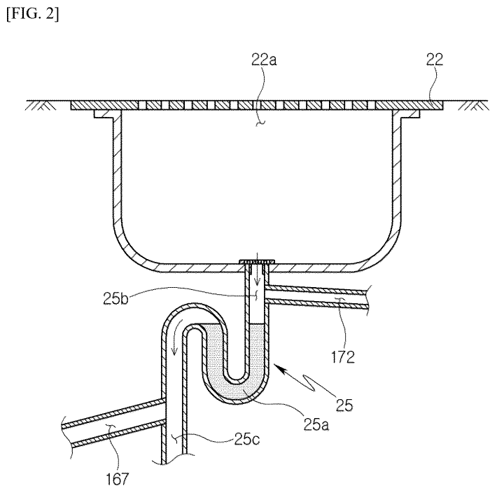

FIG. 1 is a view for explaining a state in which a cleaner system according to an embodiment of the present disclosure is installed at a lower portion of a kitchen cabinet, and FIG. 2 is a view for explaining a relationship in which piping of a cleaner system according to an embodiment of the present disclosure is connected to a drain pipe.

Referring to FIGS. 1 and 2, a cleaner system 1 according to an embodiment of the present disclosure may be provided at a lower portion of a kitchen cabinet 2. Specifically, the kitchen cabinet 2 may be disposed in a kitchen to store dishes, plates, cups, and the like, and may provide a space for cooking food or washing dishes.

In addition, the kitchen cabinet 2 may be provided with a worktop (e.g., a countertop) that may function as a sink, a cooking counter, or a workstation.

For example, the kitchen cabinet 2 may include a sink that provides a space for washing dishes on the worktop. Alternatively, the kitchen cabinet 2 may include a cooking counter for performing cooking tasks. Further, the kitchen cabinet 2 may include a range stand on which a gas range, an induction cooktop, a highlight cooktop, or an oven is installed on the worktop.

Generally, the kitchen cabinet 2 may be a standard cabinet having a width of 600 mm in a front-rear direction and a width of 600 mm in a left-right direction.

A cleaner system 1 according to another embodiment of the present disclosure may be provided at a lower portion of a structure including at least one of a water supply pipe and a drain pipe. Specifically, the water supply pipe may refer to a flow path connected to an external water source that supplies fluid to the structure, and the drain pipe may refer to a flow path that discharges fluid discharged from the structure to a sewer.

A storage cabinet for storing tableware, kitchen utensils, and the like may be provided at a lower portion of such a kitchen cabinet 2 or the structure. That is, the kitchen cabinet 2 or the structure may include a worktop 22 providing a space for tasks such as cooking or washing dishes, a bottom plate 23 disposed to be spaced apart from the ground by a predetermined height, and a storage space formed between the worktop 22 and the bottom plate 23 to store tableware, kitchen utensils, and the like. In this case, when the kitchen cabinet 2 is a sink, a sink bowl 22a may be disposed on the worktop 22.

In addition, the bottom plate 23 may be supported by a pedestal 21. The pedestal 21 is disposed along a direction perpendicular to the floor of the kitchen and may support the load of the kitchen cabinet 2. At this time, a space may be formed between the floor of the kitchen and the bottom plate 23 according to the height of the pedestal 21.

Alternatively, the kitchen cabinet 2 may be fixed to a wall of a building without the pedestal 21. Even in this case, a space may be formed between the floor of the kitchen and the bottom plate 23.

A cleaner system 1 according to an embodiment of the present disclosure is installed in a space between the floor of the kitchen and the bottom plate 23 (hereinafter, referred to as an “installation space”) as described above.

For example, the installation space may have a height of 200 mm or less, and generally, may have a height of 160 mm or less.

Accordingly, since the cleaner system 1 is disposed in the lower space of the kitchen cabinet 2, exposure of the cleaner system 1 to the outside may be minimized.

Furthermore, compared to a case where a charging dock for a robot cleaner is disposed in a certain space of a living room, a room, or a kitchen, the cleaner system 1 is disposed in an unused space created by the kitchen cabinet 2 without occupying a separate space, thereby maximizing space efficiency.

Meanwhile, the kitchen cabinet 2 or the structure is provided with a drain pipe 25 capable of draining liquids used for cooking or water used for washing dishes. At least a portion of the drain pipe 25 may be disposed in the storage space formed between the worktop 22 and the bottom plate 23. Generally, the drain pipe 25 may be connected to a drain outlet formed in the sink bowl 22a of the sink. The drain pipe 25 includes a U-trap 25a for preventing backflow of contaminated gas or malodors. The U-trap 25a may be disposed in the storage space. Liquid introduced through the drain outlet flows downward by gravity in an upstream 25b of the U-trap, accumulates in the U-trap 25a, and when water rises above a predetermined water level set by the U-trap 25a, flows downward along a downstream 25c of the U-trap to be discharged to a sewer.

The cleaner system 1 according to an embodiment of the present disclosure may wash and dry a mop 242 of the robot cleaner 200 by utilizing the drain pipe 25 as described above.

In addition, although not shown, the kitchen cabinet 2 may be provided with a water supply pipe. Fresh water (or purified water) may be supplied to the cleaner system 1 through the water supply pipe.

Hereinafter, a detailed structure of the cleaner system 1 will be described.

### Cleaner System

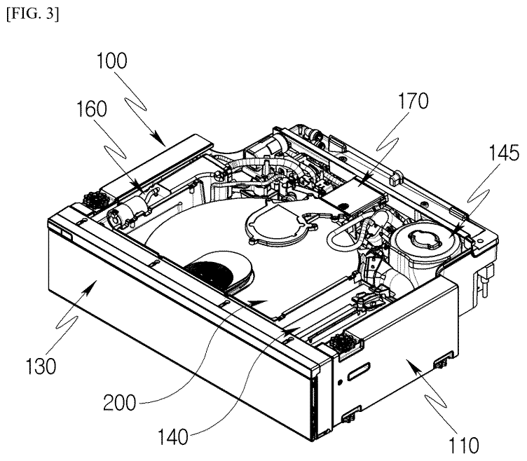

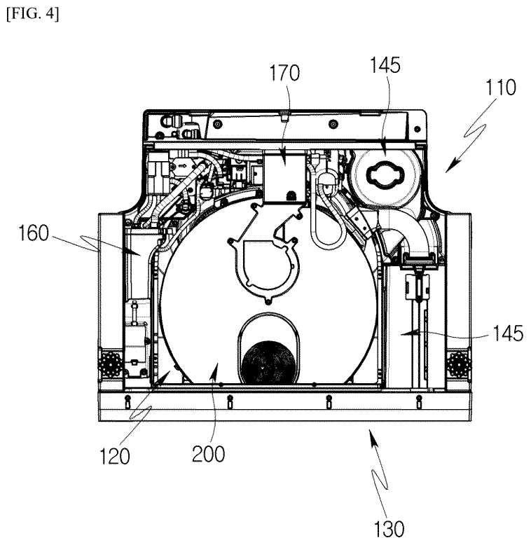

Meanwhile, FIG. 3 illustrates a perspective view for explaining a cleaner system according to an embodiment of the present disclosure. FIG. 4 illustrates a plan view of FIG. 3.

The cleaner system 1 according to embodiments of the present disclosure may include a robot cleaner station 100 and a robot cleaner 200.

The cleaner system 1 includes a robot cleaner station 100. A robot cleaner 200 may be coupled to the robot cleaner station 100. Specifically, the robot cleaner 200 may enter through a front surface of the robot cleaner station 100, and the robot cleaner 200 may be accommodated inside the robot cleaner station 100. The robot cleaner station 100 may remove dust from a dust bin 220 of the robot cleaner 200. The robot cleaner station 100 may wash a rotating cleaning unit 240 of the robot cleaner 200. The robot cleaner station 100 may dry the rotating cleaning unit 240 of the robot cleaner 200. The robot cleaner station 100 may supply power to the robot cleaner 200.

### Robot Cleaner

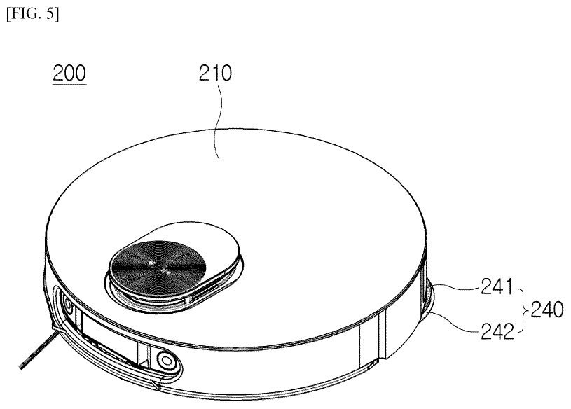

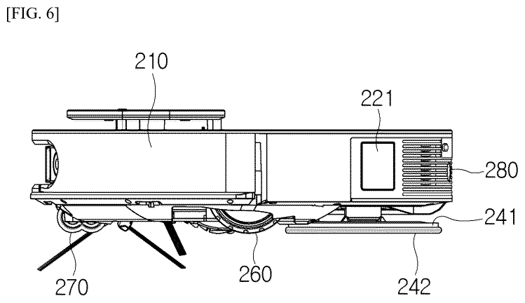

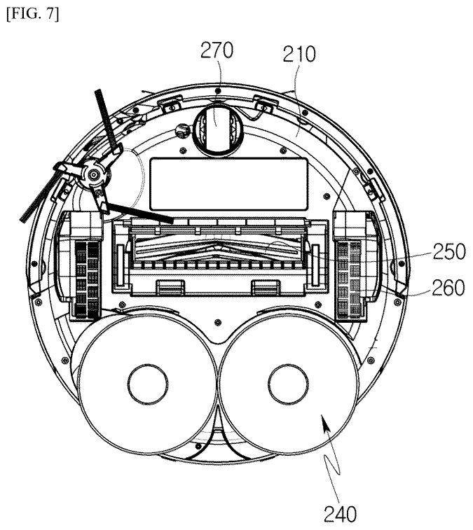

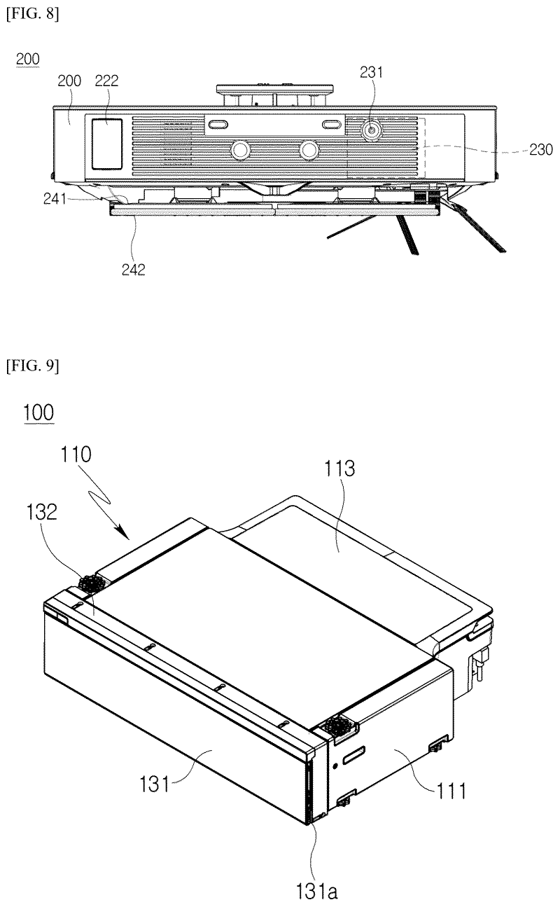

Meanwhile, FIGS. 5 to 8 disclose views for explaining a robot cleaner in a robot cleaner system according to an embodiment of the present disclosure.

The structure of the robot cleaner 200 will be described as follows with reference to FIGS. 5 to 8.

The robot cleaner 200 may automatically clean a designated area by autonomously navigating the area and suctioning foreign substances such as dust from the floor.

The robot cleaner 200 according to an embodiment of the present disclosure is configured to be placed on a floor and clean the floor while moving along a floor surface. Accordingly, hereinafter, an up-down direction will be defined and described based on a state in which the robot cleaner 200 is placed on the floor.

Further, based on a pair of wheels 260, a side where an auxiliary wheel 270 (to be described later) is disposed is defined as a front side, and a side where a rotating cleaning unit 240 (to be described later) is disposed is defined as a rear side.

A “lowest portion” of each component described in the embodiments of the present disclosure may be a portion located lowest in each component or a portion closest to the floor when the robot cleaner 200 according to an embodiment of the present disclosure is placed on the floor for use.

The robot cleaner 200 according to an embodiment of the present disclosure includes a body 210, a dust bin 220, a water tank 230, a rotating cleaning unit 240, an agitator 250, wheels 260, an auxiliary wheel 270, and a charging terminal 280.

The body 210 may form an overall appearance of the robot cleaner 200. Each component constituting the robot cleaner 200 may be coupled to the body 210, and some components constituting the robot cleaner 200 may be accommodated inside the body 210.

Specifically, components of the robot cleaner 200 may be provided within an internal space of the body 210. For example, the body 210 may accommodate a battery and at least one motor in the internal space.

In an embodiment of the present disclosure, the body 210 may be configured such that a width (or diameter) in a horizontal direction is greater than a height in an up-down direction. Such a body 210 assists the robot cleaner 200 in forming a stable structure and provides a structure advantageous for avoiding obstacles during movement (navigation).

When viewed from above or below, the body 210 may be formed in various shapes such as a circular shape, an elliptical shape, or a rectangular shape.

The body 210 may be divided into a lower body and an upper body, and the lower body and the upper body may be coupled to form a space therein.

The lower body may be coupled to the upper body to define a space capable of accommodating a battery, at least one sensor, and at least one motor therein.

The lower body may be formed with a suction port 211 through which air is introduced and holes for accommodating a pair of wheels 260.

The suction port 211 may be a passage through which dust from the floor surface is introduced. Further, the suction port 211 may communicate with a suction flow path (not shown) formed inside the body 210, and the suction flow path may communicate with an internal space of the dust bin 220.

Meanwhile, an exhaust flow path may be further provided in the lower body. One side of the exhaust flow path may communicate with the internal space of the dust bin 220, and the other side may communicate with an exhaust port. At this time, a filter may be disposed at the exhaust port.

With such a configuration, air introduced through the suction port 211 may flow into the dust bin 220 through the suction flow path and be discharged to the exhaust port through the exhaust flow path.

An agitator 250, to be described later, may be rotatably accommodated in the suction port 211. With this configuration, dust around the suction port 211 may be guided into the suction port 211 by the rotation of the agitator 250, thereby increasing dust suction efficiency.

The upper body may form an upper appearance of the robot cleaner 200. Although not shown, the upper body may be provided with a display.

The robot cleaner 200 of the present disclosure may include a bumper. The bumper is coupled along a periphery of the body 210 and is configured to move relative to the body 210.

The bumper may be coupled along a portion of the periphery of the body 210 or along the entire periphery of the body 210. At least one elastic member (not shown) may be provided between the bumper and the body 210. With this configuration, when the bumper contacts an obstacle or the like and moves relatively toward a center of the body 210, the bumper may return to its original position by a restoring force of the elastic member (not shown). This prevents or reduces the transmission of impact to the body 210 by absorbing or dispersing the impact applied to the bumper.

The dust bin 220 may be provided to suction external dust and air and store the dust.

The dust bin 220 may store dust introduced through a suction flow path. The dust bin 220 may be formed with a dust inlet communicating with the suction flow path, an internal space for storing dust, and an air outlet through which air may be discharged.

The dust bin 220 may be provided inside the body 210. In this case, the dust bin 220 may be fixedly coupled to the body 210 or may be provided to be detachable according to embodiments.

Meanwhile, in the present disclosure, a dust discharge flow path may be formed in the dust bin 220. The dust discharge flow path may communicate the internal space of the dust bin 220 with an external space of the robot cleaner 200. With this configuration, when dust is collected through the robot cleaner station 100, the dust inside the dust bin 220 may be removed.

In the meantime, a dust discharge port 221 communicating with the dust discharge flow path may be formed in the dust bin 220 according to an embodiment of the present disclosure. For example, the dust discharge port 221 may be formed at one side of a rear portion of an outer surface (or an outer peripheral surface) of the body 210. As another example, the dust discharge port 221 may be formed on an outer surface of the dust bin 220.

In addition, the robot cleaner 200 according to an embodiment of the present disclosure may be provided with a dust bin door 222 capable of selectively opening and closing the dust discharge port 221. Specifically, the dust bin door 222 is coupled to the body 210 and may be disposed at a position capable of blocking the dust discharge port 221. For example, the dust bin door 222 may be formed of a rubber or resin material and provided to be flippable, with one side fixedly coupled to the body 210.

With such a configuration, when a dust collection motor 145 of the robot cleaner station 100 (to be described later) is operated, the dust bin door 222 is elastically deformed by a driving force of the dust collection motor 145. As the dust discharge port 221 is opened, dust within the dust bin 220 may be collected into a dust collection unit 140 of the robot cleaner station 100.

The water tank 230 is formed in a container shape having an internal space so that a liquid such as water is stored therein. The water tank 230 is disposed inside the body 210 and may be fixedly coupled to the body 210 or detachably coupled to the body 210.

The water tank 230 includes a supply part 231 and a nozzle (not shown). The supply part 231 may be provided to receive a liquid such as water from the outside. For example, the supply part 231 may have an inlet formed at another side of a rear portion of an outer surface (or an outer peripheral surface) of the body 210 and may be connected to a storage space inside the water tank 230 through a water supply hose.

In this case, the supply part 231 may be disposed on an opposite side of the robot cleaner 200 in a left-right direction with respect to the dust discharge port 221. For example, if the dust discharge port 221 is disposed at a rear left side of the body 210, the supply part 231 may be disposed at a rear right side of the body 210.

Through such a configuration, in a state where the robot cleaner 200 is coupled to the robot cleaner station 100, the robot cleaner station 100 may simultaneously perform dust collection and water injection.

Meanwhile, the nozzle (not shown) is formed in a tube or pipe shape and is connected to the water tank 230 so that the liquid inside the water tank 230 can flow therethrough. One side of the nozzle (not shown) is connected to the water tank 230, and the other end is disposed to be positioned at an upper side of each of a pair of rotating plates 241 or on the rotating plates, respectively. Accordingly, the liquid inside the water tank 230 can be supplied to each of a pair of mops 242.

That is, the nozzle (not shown) may be formed in a shape in which one pipe is branched into two. In this case, one branched end is positioned at an upper side of a left mop, and the other branched end is positioned at an upper side of a right mop.

Meanwhile, although not shown, the water tank 230 is provided with a pump to allow the water inside the water tank 230 to flow to a nozzle (not shown). Therefore, when the pump of the water tank 230 is operated, the liquid stored in the water tank 230 may be discharged to the rotating cleaning unit 240 through the nozzle (not shown).

The rotating cleaning unit 240 includes a rotating plate 241 and a mop 242.

The rotating plate 241 may be provided as a pair including a left rotating plate and a right rotating plate, and the mop 242 may be provided as a pair including a left mop and a right mop.

The rotating plate 241 may be rotatably disposed on a bottom surface of the body 210, and the mop 242 may be coupled to a lower side thereof.

The rotating plate 241 is formed to have a predetermined area and is formed in a shape such as a flat plate or a flat frame. Such a rotating plate 241 is generally laid horizontally and, accordingly, is formed in a shape in which a width (or diameter) in a horizontal direction is sufficiently greater than a height in an up-down direction. The rotating plate 241 coupled to the body 210 may be parallel to a floor surface or may be inclined with respect to the floor surface. The rotating plate 241 may be formed in a circular plate shape, a bottom surface of the rotating plate 241 may be generally circular, and the rotating plate 241 may be formed in an overall rotationally symmetrical shape.

The pair of rotating plates 241 may be symmetrical to each other in a left-right direction.

The mop 242 may be coupled to a lower side of the rotating plate 241 to face the floor.

The mop 242 is formed such that a bottom surface facing the floor has a predetermined area, and the mop 242 is formed in a flat shape. The mop 242 is formed in a shape in which a width (or diameter) in a horizontal direction is sufficiently greater than a height in an up-down direction. When the mop 242 is coupled toward the body 210, the bottom surface of the mop 242 may be parallel to the floor or may be inclined with respect to the floor.

The bottom surface of the mop 242 may be generally circular, and the mop 242 may be formed in an overall rotationally symmetrical shape. In addition, the mop 242 may be detachably attached to the bottom surface of the rotating plate 241 and may be coupled to the rotating plate 241 to rotate together with the rotating plate 241.

Meanwhile, although not shown, the rotating cleaning unit 240 may be provided with a driving unit for applying a rotational force to the rotating plate 241. For example, the driving unit may include a motor and at least one gear. Accordingly, when the driving unit is operated, the rotating plate 241 and the mop 242 may rotate to wipe and clean the floor surface.

The agitator 250 is provided with a plurality of brushes rotatably to guide external dust and air to the dust bin 220. At this time, it is possible that the agitator 250 is provided with at least one gear.

Meanwhile, the agitator 250 according to the present embodiment may receive rotational power from a separate agitator motor (not shown) installed therein. Alternatively, according to embodiments, the agitator 250 may receive rotational power from a driving motor or from a driving unit of the rotating cleaning unit 240.

The wheels 260 may be provided on the bottom surface of the body 210 and may be connected to a driving unit (not shown). In this case, the driving unit (not shown) may be coupled to the body 210.

The wheels 260 are provided on the body 210 and are configured to roll on the floor.

The wheels 260 may include a first driving wheel and a second driving wheel. In this case, the first driving wheel may be identical to the second driving wheel or may be symmetrical thereto. For example, if the first driving wheel is located on a left side of the robot cleaner 200, the second driving wheel may be located on a right side of the robot cleaner 200, and the first driving wheel and the second driving wheel may be symmetrical to each other in a left-right direction.

The driving unit (not shown) may include a driving motor and gears. In this case, the driving motor is accommodated inside the body 210 and may provide power to the wheels 260. The driving motor may include a first driving motor and a second driving motor.

The driving motor may be an electric motor. A plurality of gears are configured to mesh with each other and rotate, connecting the driving motor and the wheels 260, and transmitting rotational power of the driving motor to the wheels 260. Accordingly, when a rotation shaft of the driving motor rotates, the wheels 260 may rotate.

With such a configuration, when the driving motor is operated, the wheels 260 rotate, and the body 210 may navigate on the floor surface at a predetermined travel speed.

The auxiliary wheel 270 is provided on a lower surface of the body 210 and is configured to roll on the floor surface (a surface to be cleaned). The auxiliary wheel 270 may support the body 210 on the floor surface together with the pair of wheels 260. With this configuration, the auxiliary wheel 270 may guide the movement of the robot cleaner 200 while minimizing friction between the robot cleaner 200 and the floor surface.

A suction motor (not shown) may generate a suction force capable of suctioning external dust and air through the suction port 211. For example, the suction motor (not shown) may be an electric motor. External dust and air may be introduced into the suction port 211 by the suction force generated by the suction motor (not shown), and may reach the dust bin 220 after passing through a suction flow path.

Although not shown, a battery is coupled to the body 210 and is configured to supply power to other components constituting the robot cleaner 200. The battery may supply power to at least one motor provided in the robot cleaner 200. For example, the battery may supply power to motors provided in the rotating cleaning unit 240, the agitator 250, the wheels 260, and the suction motor (not shown).

In addition, the battery may supply power to a sensor unit (not shown) and a control unit (not shown).

The battery may be charged by an external power source, and for this purpose, a charging terminal 280 for charging may be provided at one side of the body 210. For example, the charging terminal 280 may be disposed at a rear side of the outer surface of the body 210. When the robot cleaner 200 is coupled to the robot cleaner station 100, the charging terminal 280 may contact a power supply terminal 123b of the robot cleaner station 100 to receive power.

### Robot Cleaner Station

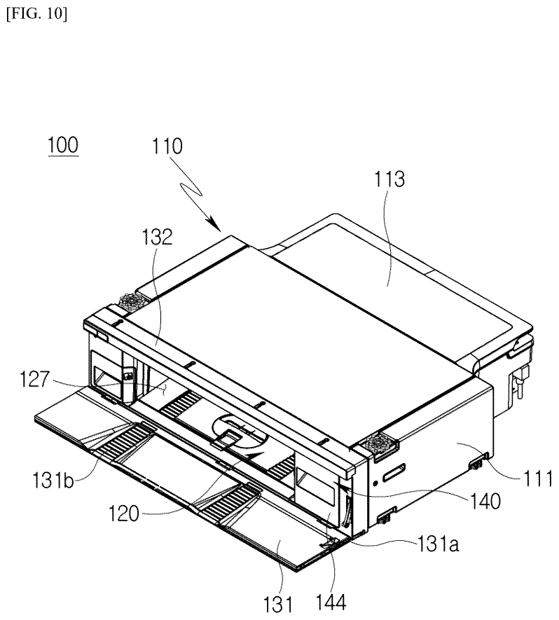

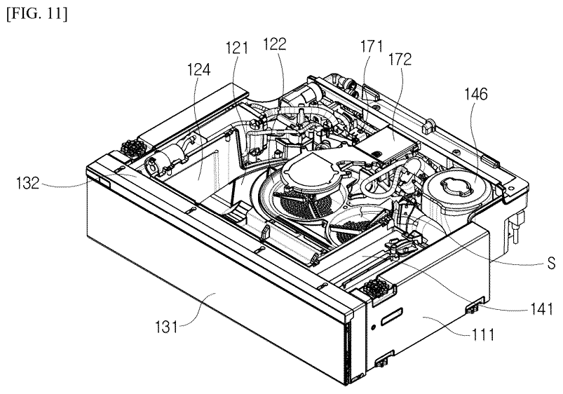

FIG. 9 is a perspective view for explaining a structure of a robot cleaner station according to an embodiment of the present disclosure. FIG. 10 is a perspective view for explaining a door unit of a robot cleaner station according to an embodiment of the present disclosure. FIG. 11 is a perspective view for explaining an internal structure of a robot cleaner station according to an embodiment of the present disclosure.

The robot cleaner station 100 of the present disclosure will be described as follows with reference to FIGS. 3 to 11.

A robot cleaner 200 may be accommodated in the robot cleaner station 100. The robot cleaner 200 may be coupled to a docking part 120 of the robot cleaner station 100.

The robot cleaner station 100 may include a housing 110.

The housing 110 may form an appearance of the robot cleaner station 100. For example, the housing 110 may be formed in a shape similar to a hexahedron including at least one outer wall surface.

The housing 110 may define a space therein capable of accommodating the docking part 120, a door unit 130, a dust collection unit 140, a mop washing unit 160, and a mop drying unit 170.

The housing 110 may be mounted at a lower portion of the kitchen cabinet 2. Specifically, the housing 110 may be installed in an installation space formed between a bottom plate 23 of the kitchen cabinet 2 and a floor of a kitchen.

The housing 110 includes a pair of outer walls 111 facing each other. The outer walls 111 may refer to surfaces formed along a direction of gravity.

For example, the pair of outer walls 111 may be installed at a lower portion of the kitchen cabinet 2 with a predetermined interval therebetween. In this case, the housing 110 further includes a bottom surface 112 facing the floor of the kitchen, and the pair of outer walls 111 may be connected to each other through the bottom surface 112.

Meanwhile, the housing 110 further includes an upper cover 113 facing the bottom plate 23 of the kitchen cabinet 2, and the upper cover 113 may be detachably coupled to upper ends of the pair of outer walls 111. Accordingly, even when foreign substances fall downward from the kitchen cabinet 2, the components of the robot cleaner 200 and the robot cleaner station 100 can be prevented from being contaminated.

In addition, the upper cover 113 may be formed in a shape in which two or more plates are overlapped. An inner cover 113b may refer to a lowermost plate among them. The inner cover 113b may cover an upper portion of an accommodation space S. Further, an outer cover 113a may refer to an uppermost plate among the upper cover 113. The outer cover 113a may face the bottom plate 23 of the kitchen cabinet 2.

In addition, the housing 110 may further include a rear surface 111b facing a wall of a building. With such a configuration, the components of the robot cleaner station 100 may be accommodated inside the housing 110 (between the pair of outer wall surfaces).

Further, the robot cleaner 200 may be accommodated inside the housing 110. The housing 110 may be arranged such that the pair of outer walls 111 have a gap greater than a maximum horizontal width of the robot cleaner 200. With this configuration, the robot cleaner 200 may enter and exit the inside of the housing 110.

In this case, in the present embodiment, the robot cleaner 200 may enter and exit through a front side of the robot cleaner station 100. Here, the front side may refer to a direction in which a door 131 is provided relative to the interior of the robot cleaner station 100.

In addition, a rear side may refer to a direction opposite to the front side relative to the interior of the robot cleaner station 100. For example, a wall of a building (not shown) may be disposed at the rear side of the robot cleaner station 100. Further, based on a view looking forward from the inside of the robot cleaner station 100, a left side may be referred to as a leftward direction, and a right side may be referred to as a rightward direction.

That is, the outer walls 111 of the robot cleaner station 100 may be respectively disposed on the left side and the right side. The outer wall disposed on the left side may be referred to as a left side surface 111c, and the outer wall disposed on the right side may be referred to as a right side surface 111d. An entrance 127 through which the robot cleaner 200 enters and exits may be formed at a front of the housing 110. A rear surface 111b may be disposed on a side opposite to the entrance 127 in the housing 110.

Accordingly, an upper side of the housing 110 is concealed by the kitchen cabinet 2, and a lower side of the housing 110 may be concealed by the floor of the kitchen. In addition, although the left and right side surfaces of the housing 110 remain covered by the outer walls, they are disposed under the kitchen cabinet 2. At this time, since the lower portion of the kitchen cabinet 2, excluding the portion where the robot cleaner station 100 is located, is finished by a baseboard 26, only the front surface of the housing 110 may consequently be exposed to the outside.

Through this, exposure of the robot cleaner Station 100 and the robot cleaner 200 to the outside can be minimized.

With such a configuration, the robot cleaner station 100 of the present disclosure has an effect of providing aesthetic appeal to a user in terms of interior design.

Meanwhile, the housing 110 may be formed with a space through which a water supply hose connected to a water supply pipe passes, a space through which a drain hose for discharging wastewater generated after washing the mop 242 passes, and a space through which a hose for discharging moisture generated during a drying process of the mop 242 passes. For example, a space through which the aforementioned hoses can pass may be formed in the outer wall 111 of the housing 110.

### Layout

The robot cleaner station 100 according to an embodiment of the present disclosure is characterized in that it is installed in a lower space of a kitchen cabinet 2.

To this end, the robot cleaner station 100 according to an embodiment of the present disclosure is characterized in that it is arranged along a horizontal direction to fit into a space formed between a bottom plate 23 of the kitchen cabinet 2 and a floor of a kitchen.

Specifically, in the robot cleaner station 100 according to an embodiment of the present disclosure, a dust collection unit 140 and/or a mop washing unit 160 may be disposed at a side of an entrance 127.

In this case, when both the dust collection unit 140 and the mop washing unit 160 are provided, a docking part 120 may be disposed between the dust collection unit 140 and the mop washing unit 160.

For example, the entrance 127 and a door 131 may be disposed at a front of the robot cleaner station 100. Further, the docking part 120, to which the robot cleaner 200 is coupled, may be disposed rearward from the entrance 127. At this time, the dust collection unit 140 may be disposed from a front end of the robot cleaner station 100 to a rearward position by a predetermined length. In addition, the mop washing unit 160 may also be disposed from the front end of the robot cleaner station 100 to a rearward position by a predetermined length.

Accordingly, when viewing the robot cleaner station 100 from an outer front side thereof, a front end of the dust collection unit 140 and/or a front end of the mop washing unit 160 may be disposed on left and right sides of the entrance 127.

In this case, a dust bag drawer 144 of the dust collection unit 140 may be provided to be withdrawable toward the front of the housing 110. Also, a detergent tank 163 of the mop washing unit 160 may be provided to be withdrawable toward the front of the housing.

Meanwhile, rear ends of a dust collection unit housing 141 and the detergent tank 163 may be spaced apart from a rear end of the housing 110 by a predetermined interval. A dust collection motor 145 may be disposed between the rear end of the dust collection unit housing 141 and the rear end of the housing 110. With this configuration, there is an effect of minimizing the total space occupied by the docking part 120, the dust collection unit housing 141, and the dust collection motor 145 within a limited space.

In addition, a flow path through which washing water for washing the mop 242 can flow may be at least partially disposed between the rear end of the housing 110 and a rear end of the detergent tank 163. With this configuration, a path through which washing water is introduced from a water supply pipe can be minimized. Furthermore, there is an effect of minimizing the total space occupied by the docking part 120, the detergent tank 163, and the flow path through which the washing water flows within a limited space.

Meanwhile, in the robot cleaner station 100, a mop drying unit 170 may be disposed rearward of the docking part 120. In this case, the mop drying unit 170 may be disposed between a rear end of the docking part 120 and the rear end of the housing 110.

Accordingly, in the robot cleaner station 100 according to an embodiment of the present disclosure, the dust collection unit 140 and the mop washing unit 160 are disposed on left and right sides relative to the docking part 120, and the mop drying unit 170 may be disposed at a rear side thereof.

That is, in the robot cleaner station 100 according to an embodiment of the present disclosure, the dust collection unit 140, the mop washing unit 160, and the mop drying unit 170 may all be disposed within a predetermined distance range from a periphery of the docking part 120.

This configuration has an effect of minimizing flow loss by shortening a distance between the dust bin 220 of the robot cleaner 200 and the dust collection unit 140. In addition, by minimizing a distance between the mop 242 and the mop washing unit 160 and a distance between the mop 242 and the mop drying unit 170, the range where washing water and wastewater exist can be limited.

Furthermore, such an arrangement allows the robot cleaner station 100 of the present disclosure to dispose all constituent components within a limited height.

Consequently, in the robot cleaner station 100 according to an embodiment of the present disclosure, the dust collection unit 140, the mop washing unit 160, and the mop drying unit 170 may be disposed on three sides surrounding the docking part 120, except for the front surface through which the robot cleaner 200 enters. Through this arrangement, even in a situation where the vertical height is restricted, the robot cleaner 200 can be charged, dust can be collected, and the mop 242 can be washed and dried while utilizing a minimum horizontal space.

### Docking Portion

As shown in FIGS. 10 and 11, the robot cleaner station 100 may include a docking portion 120.

The robot cleaner 200 and the robot cleaner station 100 may be connected physically, electrically, and/or fluidly through the docking portion 120.

The docking portion 120 may be disposed inside the housing 110.

An entrance 127, through which the robot cleaner 200 is introduced, may be formed at a front of the docking portion 120. The entrance 127 may refer to a space formed on a front surface of the robot cleaner station 100.

The entrance 127 may be formed in a size through which the robot cleaner 200 can pass. That is, a height of the entrance 127 is formed to be greater than a height of the robot cleaner 200. In this case, the entrance 127 may refer to a space formed upward along a vertical direction from a front end of a base 121, which will be described later. Alternatively, the entrance 127 may refer to a hole formed in a door frame 132, which will be described later, through which the robot cleaner 200 passes.

At least one of the dust collection unit 140 and the mop washing unit 160 may be disposed on left and right sides of the entrance 127. Accordingly, left and right ends of the entrance 127 may form boundaries with the dust collection unit 140 and the mop washing unit 160.

At this time, the entrance 127 may be opened and closed by a door 131.

The docking portion 120 may include an accommodation space S, a base 121, a coupling wall 123, and an inner wall 124.

At least a portion of the robot cleaner 200 may be accommodated in the accommodation space S of the docking portion 120. For example, the accommodation space S may refer to a space surrounded by the base 121, the coupling wall 123, and the inner wall 124. As another example, the accommodation space S may refer to a space surrounded by the base 121, a washing plate 122, the coupling wall 123, and the inner wall 124. As yet another example, the accommodation space S may refer to a space where the robot cleaner 200 is positioned in a state where the robot cleaner 200 is coupled to the power supply terminal 123b, or a space where the robot cleaner 200 is positioned in a state where the dust bin 220 of the robot cleaner 200 communicates with a dust passage hole 123a. The accommodation space S may refer to a space formed between the base 121 and the upper cover 113.

The base 121 is configured to support the robot cleaner 200 when the robot cleaner 200 is coupled to the robot cleaner station 100. The wheels 260 of the robot cleaner 200 may contact an upper surface of the base 121. In addition, the auxiliary wheel 270 of the robot cleaner 200 may contact the upper surface of the base 121.

The base 121 may include a base body 121a, an inclined portion 121b, a wheel coupling portion 121c, an agitator accommodation portion 121d, and a washing tub 128.

The base body 121a may form an overall appearance of the base 121. The inclined portion 121b, the wheel coupling portion 121c, the agitator accommodation portion 121d, and the washing tub 128 may be disposed on the base body 121a.

The base body 121a may be formed in a shape in which a horizontal length and width are greater than a height in an up-down direction. Due to such a structure, the robot cleaner station 100 can be stably supported on a floor surface.

A reflux flow path may be provided inside the base body 121a. Accordingly, air discharged from the dust collection motor 145 may flow through a reflux flow path 125a formed inside the base body 121a and be exhausted through an air reflux port 125b.

The inclined portion 121b may be disposed at an inlet of the base body 121a where the robot cleaner 200 climbs.

The inclined portion 121b may have an upward slope toward a front in a direction in which the robot cleaner 200 enters. More specifically, a front end of the inclined portion 121b is connected to the ground such that there is no height difference, and may have an upward slope toward the rear. That is, the inclined portion 121b may be formed to gradually rise from the ground when the robot cleaner 200 enters. Accordingly, the robot cleaner 200 can easily climb from the ground onto the robot cleaner station 100.

The wheels 260 of the robot cleaner 200, having moved upward along a wheel guide portion 121ba, may be seated on the wheel coupling portion 121c. When the wheels 260 of the robot cleaner 200 are seated on the wheel coupling portion 121c, physical coupling between the robot cleaner 200 and the robot cleaner station 100 may be achieved. A surface of the wheel coupling portion 121c may be formed to correspond to a surface of the wheel 260 so that the robot cleaner 200 can stably stop. The wheel coupling portion 121c may extend from an upper end of the wheel guide portion 121ba. The wheel coupling portion 121c may be connected to the wheel guide portion 121ba without a step. Accordingly, the robot cleaner 200 can easily move past the inclined portion 121b to the wheel coupling portion 121c.

The wheel coupling portion 121c may be disposed at a stopping position of left and right wheels 260 of the robot cleaner 200 so that the robot cleaner 200 stops at a designated position. Here, the stopping position of the wheels 260 refers to a position predetermined for the robot cleaner 200 to stop in order to couple with the power supply terminal 123b and/or a position predetermined for the robot cleaner 200 to stop so that the dust bin 220 of the robot cleaner 200 communicates with the dust passage hole 123a.

The wheel coupling portion 121c may be formed in a shape corresponding to a shape of the wheel 260 of the robot cleaner 200, that is, an arch shape. Through this configuration, while moving along the wheel guide portion 121ba, the robot cleaner 200 may stop simultaneously with the wheels 260 being inserted into the wheel coupling portion 121c, and the wheels 260 may be stably seated in the arch-shaped wheel coupling portion 121c.

At least a portion of the agitator 250 of the robot cleaner 200 may be accommodated in the agitator accommodation portion 121d.

The agitator accommodation portion 121d may be formed between the wheel coupling portions 121c. The agitator accommodation portion 121d may be formed in a shape corresponding to the agitator 250 of the robot cleaner 200. The agitator accommodation portion 121d may be formed in a rectangular parallelepiped shape with an open top. A bottom surface of the agitator accommodation portion 121d may be sealed by a bottom surface of the base body 121a or a bottom surface of the housing 110. Accordingly, the agitator 250 of the robot cleaner 200, having moved upward along the inclined portion 121b, may be seated in the agitator accommodation portion 121d. In this case, a depth of the agitator accommodation portion 121d may be formed to be shallower than a depth of the wheel coupling portion 121c.

The agitator accommodation portion 121d may be formed to be recessed in the base body 121a. Through this, in a state where the wheels 260 of the robot cleaner 200 are seated in the wheel coupling portion 121c, the agitator accommodation portion 121d may provide a space in which a lower end of the agitator 250 is accommodated.

An air reflux port 125b may be formed in the agitator accommodation portion 121d. The air reflux port 125b may be formed on a side surface of the agitator accommodation portion 121d. The air reflux port 125b may connect the agitator accommodation portion 121d with the dust collection motor 145 through a reflux flow path. The agitator accommodation portion 121d and the reflux flow path may communicate with each other through the air reflux port 125b. Accordingly, air discharged from the dust collection motor 145 may pass through the air reflux port 125b and be discharged into the agitator accommodation portion 121d.

The agitator accommodation portion 121d may guide the air discharged through the air reflux port 125b to the suction port 211 of the robot cleaner 200.

Meanwhile, the base 121 may be provided to be withdrawable from the housing 110 and a drawer 190. In this case, the base 121 may be withdrawn through the entrance 127 along a space between the inner walls 124.

To facilitate this, a base handle 121e may be formed on the base 121. The base handle 121e may be formed between the agitator accommodation portion 121d and an auxiliary wheel guide portion 121bb. Additionally, the base handle 121e may be formed between a pair of wheel guide portions 121ba.

The base handle 121e may be formed in a shape in which the base body 121a is recessed, specifically recessed from a rear side toward a lower front side. For example, the base handle 121e may be formed in an elliptical groove shape, having a cover formed at a front side thereof and being open at a rear side thereof.

With such a configuration, a user can easily withdraw the base 121 by grasping and pulling the handle 121e.

A coupling wall 123 is a configuration in which a dust passage hole 123a, a power supply terminal 123b, and a water supply nozzle 123c of the robot cleaner station 100 are disposed. The coupling wall 123 may spatially divide the accommodation space S from other components of the robot cleaner station 100. The coupling wall 123 may extend along a vertical direction from a rear side of the base 121. The coupling wall 123 may be formed to correspond to a shape of the robot cleaner 200. For example, when a body 210 of the robot cleaner 200 has a cylindrical shape, the coupling wall 123 may be formed in an arc shape having a predetermined radius. With this configuration, the coupling wall 123 can surround a periphery of the robot cleaner 200 and increase an area facing an outer surface of the robot cleaner 200. Furthermore, the robot cleaner 200 can be stably supported.

A dust passage hole 123a may be formed in the docking portion 120 so that air from outside the housing 110 can be introduced into the interior. Specifically, the dust passage hole 123a may be formed in the coupling wall 123 so that air from outside the housing 110 can be introduced into the interior. In this case, the dust passage hole 123a may be disposed at a rear of a dust collection unit housing 141, which will be described later.

The dust passage hole 123a may communicate with the dust bin 220 of the robot cleaner 200. Specifically, the dust passage hole 123a may communicate with a dust discharge port 221 of the dust bin 220 of the robot cleaner 200. The dust passage hole 123a may be formed in a hole shape corresponding to a shape of the dust bin 220 so that dust from the dust bin 220 is introduced into the dust collection unit 140.

The dust passage hole 123a may be formed to communicate with dust collection flow paths 147 and 148. Air suctioned through the dust passage hole 123a may flow through the dust collection flow paths 147 and 148 and then be exhausted through an air reflux portion 125.

The robot cleaner station 100 may include a power supply module for supplying power to the robot cleaner 200. The power supply module includes a power supply module housing and a power supply terminal 123b, and a circuit board and elements for power supply may be mounted within the power supply module housing. Further, the power supply terminal 123b may be disposed forward of the power supply module housing so as to be exposed on the coupling wall 123.

The power supply terminal 123b may supply power to the robot cleaner 200 coupled to the docking portion 120. The power supply terminal 123b may be electrically connected by contacting a charging terminal of the robot cleaner 200. The power supply terminal 123b may be disposed at the docking portion 120. Specifically, the power supply terminal 123b may be disposed on the coupling wall 123. The power supply terminal 123b may be electrically connected to the robot cleaner 200 coupled to the coupling wall 123 and may supply power to a battery of the robot cleaner 200.

The robot cleaner station 100 may further include a water supply nozzle 123c.

The water supply nozzle 123c may be connected to a supply part 231 of a water tank 230 of the robot cleaner 200. Specifically, the water supply nozzle 123c may be connected to an inlet of the water tank 230. The water supply nozzle 123c may supply water provided from a water supply pipe of a kitchen cabinet 2 to a storage space inside the water tank 230 of the robot cleaner 200.

Furthermore, the robot cleaner station 100 may further include a coupling guide 123d. In a state where the robot cleaner 200 is seated in the docking portion 120, the coupling guide 123d may be engaged with a coupling groove formed in the robot cleaner 200. Through this, the coupling guide 123d may guide the robot cleaner 200 to be accurately coupled to a designated position. The coupling guide 123d may be disposed between a pair of air discharge portions 171c.

Additionally, the coupling guide 123d may include a sensor for sensing a coupling state. Through this, it can be detected whether the robot cleaner 200 is correctly seated.

The inner wall 124 is a configuration that spatially divides an accommodation space S of the docking portion 120 from other components of the robot cleaner station 100. A pair of inner walls 124 may be disposed on left and right sides of the base 121. The inner walls 124 may be connected to both ends of the coupling wall 123. The inner walls 124 may extend from the left and right sides of the base 121 in a direction intersecting the base 121. Specifically, the inner walls 124 may extend in a vertical direction from the left and right sides of the base 121.

Meanwhile, various components such as dust collection flow paths 147 and 148, a dust collection unit 140, a dust collection motor 145, a detergent tank 163, and a wastewater tank 166 may be disposed outside the inner wall 124. Specifically, the dust collection unit 140, the detergent tank 163, and the wastewater tank 166 may be disposed in a space between the inner wall 124 and an outer wall 111 of the housing 110.

The dust collection unit 140 and the detergent tank 163 may be separable from the space between the inner wall 124 and the outer wall 111 of the housing 110 in a sliding manner. A horizontal width of each of the dust collection unit 140 and the detergent tank 163 may be smaller than a distance between the inner wall 124 and the outer wall 111 of the housing 110.

A washing plate 122 is a configuration for washing the mop of the robot cleaner 200, and the washing plate 122 may be seated in a washing tub 128 of the base 121. Further, the washing plate 122 may contact the mop 242 in a state where the robot cleaner 200 is docked.

The washing plate 122 may be a plate generally formed to slope downward toward a central portion thereof.

Specifically, the washing plate 122 includes a flow guide surface 122c formed in a curved shape. Additionally, at least one passage hole 122b through which fluid can pass may be formed in the flow guide surface 122c. Furthermore, washing protrusions 122a may be formed to protrude from the flow guide surface 122c.

In this case, a pair of washing protrusions 122a may be formed symmetrically on the flow guide surface 122c. Specifically, the pair of washing protrusions 122a are disposed vertically below a pair of mops 242 of the robot cleaner 200 to face the pair of mops 242, and may be arranged to be contactable with at least a portion of the pair of mops 242.

A plurality of passage holes 122b are formed in the flow guide surface 122c and may be disposed between the pair of washing protrusions 122a. For example, the plurality of passage holes 122b may include a position having a lowest height from the ground (floor of the kitchen) on the flow guide surface 122c and be formed between the pair of washing protrusions 122a. Through this, fluid discharged between the pair of washing protrusions 122a can be guided to and flow through the passage holes 122b.

Meanwhile, a height of the flow guide surface 122c from the floor of the kitchen may increase toward the rear from the position where the passage holes 122b are formed. That is, the height of the flow guide surface 122c from the floor of the kitchen may increase as it approaches an air discharge portion 171c, which will be described later.

With this configuration, washing water and/or air flows along the flow guide surface 122c and can escape through the passage holes 122b into a space formed between the washing plate 122 and the washing tub 128.

When washing water is supplied to the washing plate 122 and the mop 242 rotates, the mop 242 can be washed by friction with the washing protrusions 122a which remain in a stationary state.

Meanwhile, at least a portion of the washing plate 122 may be disposed above a flow path forming portion 128c, which will be described later. That is, the washing plate 122 may further include a reflux flow path cover portion 122d that protrudes upward from the flow guide surface 122c and is coupled to an upper side of the flow path forming portion 128c.

The washing plate 122 of the present embodiment may be formed in a shape corresponding to a shape of the flow path forming portion 128c. For example, a front left part of the washing plate 122 may protrude upward from the flow guide surface 122c to cover the flow path forming portion 128c located below.

With this configuration, the washing plate 122 and the washing tub 128 can be accurately coupled, while simultaneously providing sufficient space to define the reflux flow path 125a.

The washing tub 128 is a configuration in which the washing plate 122 is seated. The washing tub 128 may be disposed at a rear side of the base body 121a. The washing tub 128 is disposed below the washing plate 122 and is detachably coupled to the washing plate 122. The washing tub 128 may be formed to correspond to the washing plate 122 so that the washing plate 122 can be fitted therein. Liquid that has passed through the washing plate 122 may be introduced into the washing tub 128.

The washing tub 128 may include a washing tub base surface 128a through which the fluid that has passed through the washing plate 122 flows, and a washing tub wall 128b protruding and extending in a vertical direction from a periphery of the washing tub base surface 128a. In this case, a height of the washing tub base surface 128a from the ground (floor of the kitchen) may decrease toward a rear of the robot cleaner station 100. Through this, the fluid that has passed through the washing plate 122 can be collected at a rear of the washing tub 128 and discharged to the outside through a wastewater inlet 164c, which will be described later.

At this time, for coupling with the wastewater inlet 164c, a wastewater pipe connector 128d may be formed on the washing tub wall 128b.

Meanwhile, a flow path forming portion 128c may be formed in the washing tub 128. The flow path forming portion 128c may protrude upward from the washing tub base surface 128a to define a reflux flow path 125a at a lower side thereof. Specifically, at least a portion of the reflux flow path 125a may be formed between the lower surface of the base 121 and the flow path forming portion 128c.

In the meantime, the washing tub 128 according to the present disclosure is provided to be withdrawable from the mop washing unit 160. That is, the washing tub 128 may be withdrawn from the housing 110 together with the base 121. Along with this, the washing plate 122 is also withdrawable from the mop washing unit 160.

### Door Unit

The door unit 130 may be provided to cover the entire front end of the housing 110. A door 131 may cover the dust bag drawer 144 and the detergent tank 163 to prevent them from being exposed to the outside.

The door 131 may form a front appearance of the robot cleaner station 100 in a state where the entrance 127 is closed. For example, the door 131 may be formed in a shape close to a rectangular flat plate. A length of the door 131 in the left-right direction may be provided to be greater than or equal to a length of the housing 110 in the left-right direction. With this configuration, the dust bag drawer 144 and the detergent tank 163 can be protected from the outside, and the appearance of the robot cleaner station 100 can be kept clean.

A door frame 132 may be disposed at the front of the housing 110. The door 131 is coupled to the door frame 132 so as to be openable and closable. In addition, the door frame 132 may be formed with the entrance 127 through which the robot cleaner 200 enters and exits, a dust bag withdrawal port 132a to which the dust bag drawer 144 is withdrawably coupled, and a detergent tank insertion port 132b to which the detergent tank 163 is withdrawably coupled.

The door frame 132 may form the front appearance of the robot cleaner station 100 when the door 131 is in an open state.

In a state where the door 131 opens the entrance 127, at least one surface of the dust bag drawer 144 coupled to the door frame 132 and at least one surface of the detergent tank 163 may be exposed to the outside. When the door 131 opens the entrance 127, a front surface of the dust bag drawer 144 and a front surface of the detergent tank 163 are exposed to the outside, and a handle 144d of the dust bag drawer 144 and a handle 163b of the detergent tank 163 are exposed. With this configuration, the dust bag drawer 144 and the detergent tank 163 can be easily withdrawn or inserted, and a clean appearance can be provided.

A rotation shaft 131a of the door 131 is disposed at a lower end of the door frame 132. When the entrance 127 is opened, the door 131 may be disposed parallel to the floor surface, or may be formed to slope downward toward the front such that an end thereof contacts the ground.

The door 131 may include a hinge part and be rotatably connected to the door frame 132. A plurality of hinge parts may be disposed to be spaced apart from each other along the rotation shaft 131a, and may be arranged at different intervals.

In addition, a sub-ramp 131b may be provided on a surface of the door 131 facing the housing 110 when the entrance 127 is closed. The sub-ramp 131b is provided so that the robot cleaner 200 can stably navigate toward the docking portion 120 or the entrance 127, and may be provided to be inclined upward toward the rear.

Specifically, the sub-ramp 131b may be formed in a groove shape for stable inclined navigation of the robot cleaner 200. In the sub-ramp 131b, grooves formed along a left-right direction may be disposed to be spaced apart at equal intervals in a front-rear direction. Such a sub-ramp 131b may be formed such that a width in the left-right direction narrows toward the rear. Accordingly, as the wheels 260 of the robot cleaner 200 move toward the docking portion 120 or the entrance 127, their left-right movement is restricted, and they can be guided to a designated position.

The sub-ramp 131b guides the wheels 260 to a wheel guide portion 121ba disposed in the docking portion 120. The sub-ramp 131b may be provided as a pair and disposed at respective positions continuous with a pair of wheel guide portions 121ba.

Meanwhile, the door 131 may be driven according to whether the robot cleaner 200 approaches or whether a cleaning operation starts, or may be driven according to an input from a door manipulation unit 133.

An entry sensor 135 may be installed on the door frame 132 to recognize the approach of the robot cleaner 200. The entry sensor 135 may be disposed at a front of the housing 110 so as to recognize the approach of the robot cleaner 200. For example, the entry sensor 135 may be an IR sensor.

The entry sensor 135 may be installed at an upper portion of a front surface of the door frame 132. Through this, a sensing range can be maximized. In addition, the entry sensor 135 may be installed at a center of the entrance 127 in the left-right direction. Through this, an entry direction of the robot cleaner 200 can be guided through communication with the robot cleaner 200.

Meanwhile, so that the entry sensor 135 can sense the front even in a state where the door 131 closes the entrance 127, a position of the door 131 facing the entry sensor 135 may be formed in a cut-out shape. Alternatively, a transparent window may be provided at a position of the door 131 facing the entry sensor 135.

A door manipulation unit 133 may be installed on the door frame 132 so that the door 131 can be rotated by a user's manipulation.

The door manipulation unit 133 is disposed on the door frame 132 and may include at least one button for driving the door 131. The door manipulation unit 133 may rotate the door 131 regardless of the position or state of the robot cleaner 200. The door manipulation unit 133 may include a single button for opening or closing the door 131, or may respectively include a button for opening the door 131 and a button for closing the door 131.

The door manipulation unit 133 may be disposed inside the door frame 132. Further, the door manipulation unit 133 may be arranged such that at least one button is exposed to the outside.

In this case, the button may be disposed adjacent to the detergent tank 163 relative to the entrance. For example, the button may be disposed above a handle 163b of the detergent tank 163.

Meanwhile, when the door 131 closes the entrance 127, it also covers the door manipulation unit 133. At this time, an external button portion 131c is provided on the door 131 so that the door manipulation unit 133 can be operated even in a state where the entrance 127 is closed. The external button portion 131c includes the same number of buttons as those of the door manipulation unit 133, and each is provided at a position facing a corresponding button. The external button portion 131c is formed of an elastically deformable material and can press the button when an external force is applied.

The door 131 may be rotated by a door driving unit 134. For example, the door driving unit 134 may include a door driving motor and a driving gear portion.

The door driving motor may be disposed inside the housing 110 and may be disposed in an upper space of the detergent tank 163. Specifically, the door driving motor may be disposed between the detergent tank 163 and the upper cover 113 of the housing 110. In addition, the door driving motor may be disposed at a front side within a space provided between the outer wall 111 and the docking portion 120. That is, the door driving motor may be disposed adjacent to the door manipulation unit 133.

Through this, space utilization is improved and accessibility is enhanced, thereby providing convenience to a user.

The driving gear portion is provided to connect the door driving motor and the door 131 to transmit power. The driving gear portion transmits a driving force of the door driving motor to the door 131 to rotate the door 131.

### Dust Collection Unit

The dust collection unit 140 may collect dust from the dust bin 220 of the robot cleaner 200. The dust collection unit 140 may be disposed inside the housing 110. The dust collection unit 140 may be disposed outside the docking portion 120. That is, the dust collection unit 140 may be disposed between the housing 110 and the docking portion 120. For example, the dust collection unit 140 may be disposed at one side of the docking portion 120 in a left-right direction.

The dust collection unit 140 may include a dust collection unit housing 141, a filter 142, a dust bag 143, a dust bag drawer 144, a dust collection motor 145, a dust collection motor housing 146, a first dust collection flow path 147, and a second dust collection flow path 148.

The dust collection unit housing 141 may define a space therein capable of accommodating the filter 142, the dust bag 143, and the dust bag drawer 144.

The dust bag drawer 144 is withdrawably coupled to the inside of the dust collection unit housing 141, and the dust bag 143 may be stored inside the dust bag drawer 144. For example, the dust collection unit housing 141 is formed in a rectangular tube shape with an open front, and a rear internal space thereof may communicate with the first dust collection flow path 147 and the second dust collection flow path 148.

Dust inside the dust bin 220 may be introduced into the dust collection unit housing 141.

One side of the interior of the dust collection unit housing 141 may communicate with the first dust collection flow path 147, and the other side may communicate with the second dust collection flow path 148. In addition, when the dust bag 143 is coupled to the dust collection unit housing 141, the dust bag 143 may communicate with the first dust collection flow path 147 inside the dust collection unit housing 141.

The filter 142 may be provided in the dust bag drawer 144. Specifically, the filter 142 is disposed inside the dust bag drawer 144 and may be withdrawn together with the dust bag drawer 144.

Meanwhile, the filter 142 may be disposed lower than an inlet 141b relative to a bottom surface of a dust bag drawer body 141a. The filter 142 may be disposed forward of a discharge port 144c of the dust bag drawer 144.

Specifically, the filter 142 may be detachably coupled to a lower surface of the dust bag drawer 144. In this case, the filter 142 may be disposed at one longitudinal (front) end of a flow path forming portion 144e. Accordingly, the filter 142 may be disposed between a handle 144d and the flow path forming portion 144e. That is, the filter 142 may be disposed adjacent to a front surface of the dust bag drawer 144.

The filter 142 may be withdrawn together with the dust bag drawer 144 when the dust bag drawer 144 is withdrawn. That is, when the handle 144d is pulled, the filter 142 can be withdrawn together with the dust bag drawer 144. In this case, since the filter 142 is disposed immediately behind the handle 144d, there is an advantage in that a user can easily replace the filter 142 even in a state where only a portion of the dust bag drawer 144 is withdrawn.

Meanwhile, the filter 142 may be disposed to be spaced apart from both side surfaces of the dust bag drawer 144 in a left-right direction (width direction). That is, a space may be formed between the filter 142 and both side surfaces of the dust bag drawer body 144a in the left-right direction. In this case, a user's finger may enter the space.

With such a configuration, there is an effect that the user can separate the filter 142 through a simple operation of inserting a finger into the space between the filter 142 and the dust bag drawer body 144a and pulling the filter 142.

The filter 142 may be disposed lower than the dust bag 143. At this time, the dust bag 143 may be detachably coupled to the dust bag drawer 144 in a sliding manner along a vertical direction.

Accordingly, the dust bag 143 can be separated from the dust bag drawer 144 along the vertical direction in a state where the dust bag drawer 144 is withdrawn, and the filter 142 can be exposed to the outside when the dust bag 143 is separated.

Therefore, every time the user replaces the dust bag 143, the state of the filter 142 can be checked, and there is an effect that the filter 142 can also be easily replaced along with the replacement of the dust bag 143.

The dust bag 143 may refer to a dust pouch that collects dust suctioned from the inside of the dust bin 220 of the robot cleaner 200 by the dust collection motor 145.

The dust bag 143 may be detachably coupled to the dust bag drawer 144. Accordingly, the dust bag 143 can be separated from the dust bag drawer 144 to be discarded, and a new dust bag 143 can be coupled to the dust bag drawer 144. That is, the dust bag 143 may be defined as a consumable component.

An inlet of the dust bag 143 may be disposed to communicate with an inlet 144b of the dust bag drawer 144. Accordingly, when the dust collection motor 145 is operated, air and dust within the dust bin 220 can be introduced into and collected in the dust bag 143.

The dust bag 143 may be provided such that when suction force is generated by the dust collection motor 145, its volume increases and dust is accommodated therein. To this end, the dust bag 143 may be made of a material that is air-permeable but impermeable to foreign substances such as dust. For example, the dust bag 143 may be made of a non-woven fabric material and may have a hexahedral shape corresponding to a shape of the dust bag drawer 144 when the volume is increased.

The dust collection unit 140 may further include a dust collection module. The dust collection module may provide a suction airflow to a dust collection flow path.

Specifically, the dust collection unit 140 may further include a dust collection motor 145 and a dust collection motor housing 146.

The dust collection motor 145 may generate a suction force in the dust collection flow paths 147 and 148. That is, the dust collection motor 145 may provide a suction force for suctioning dust within the dust bin 220 into the dust bag 143 disposed inside the dust collection unit housing 141.

The dust collection motor 145 may be disposed at a rear of the dust collection unit housing 141. Through this, the dust collection motor 145 may provide a suction force capable of suctioning dust within the dust bin 220 of the robot cleaner 200.

The dust collection motor 145 may generate a suction force through rotation. For example, although not shown, the dust collection motor 145 may include a rotor and a stator that rotate relative to each other by receiving power, and may include an impeller that rotates about a rotation shaft according to the rotation of the rotor. Accordingly, the suction force may be generated by the rotation of the impeller.

One side of the dust collection motor 145 may be connected to the second dust collection flow path 148, and the other side may be connected to the reflux flow path 125a. When the dust collection motor 145 is driven, air flowing through the second dust collection flow path 148 may be introduced into the dust collection motor housing 146. In addition, the air introduced into the dust collection motor housing 146 may flow through the reflux flow path 125a after passing through the dust collection motor 145.

Meanwhile, in the present embodiment, a rotation shaft of the dust collection motor 145 may be disposed along a vertical direction. In this case, horizontal space occupied by the dust collection motor 145 can be minimized.

On the other hand, when the rotation shaft of the dust collection motor 145 is disposed along the vertical direction, a side where air is introduced into the dust collection motor 145 and a side where air is discharged from the dust collection motor 145 may be disposed at different heights. Accordingly, the structure of the dust collection motor housing 146 may be formed.

The dust collection motor housing 146 may accommodate the dust collection motor 145 therein. The dust collection motor housing 146 may be disposed at a rear of the dust collection unit housing 141. In addition, the dust collection motor housing 146 may be disposed at a rear of the first dust collection flow path 147. Furthermore, the dust collection motor housing 146 may be disposed at a rear of the second dust collection flow path 148.

That is, based on a front-rear direction of the robot cleaner station 100, the dust collection unit housing 141 is disposed at the foremost position, and the first dust collection flow path 147 and the second dust collection flow path 148 may be disposed at a rear of the dust collection unit housing 141. In addition, the dust passage hole 123a may be disposed rearward of the first dust collection flow path 147, and the dust collection motor housing 146 may be disposed rearward of the second dust collection flow path 148. Furthermore, the dust collection motor housing 146 may be disposed rearward of the dust passage hole 123a.

Accordingly, the dust collection unit 140 is generally disposed along the front-rear direction of the robot cleaner station 100, which has an effect of reducing the overall height.

Meanwhile, the dust collection unit 140 may further include dust collection flow paths 147 and 148. The dust collection flow paths may refer to flow paths through which air suctioned through the dust passage hole 123a flows through the dust bag to reach the dust collection motor 145.

Specifically, when the robot cleaner 200 is coupled to the robot cleaner station 100 such that the dust passage hole 123a communicates with the dust bin 220 of the robot cleaner 200, the dust collection flow paths may include a first dust collection flow path 147 communicating the dust bin 220 with the internal space of the dust collection unit housing 141, and a second dust collection flow path 148 communicating the internal space of the dust collection unit housing 141 with the internal space of the dust collection motor housing 146.

The first dust collection flow path 147 may connect the dust bin 220 of the robot cleaner 200 with the internal space of the dust collection unit housing 141. The first dust collection flow path 147 may connect the dust passage hole 123a of the docking portion 120 with the internal space of the dust collection unit housing 141. The first dust collection flow path 147 may be formed along a direction intersecting a vertical direction. For example, the first dust collection flow path 147 may be formed substantially in a horizontal direction. The first dust collection flow path 147 may be a space formed rearward from the dust passage hole 123a, and may be a flow path bent toward a side from the dust passage hole 123a so that dust and air can flow therethrough. Dust within the dust bin 220 of the robot cleaner 200 may move to the internal space of the dust collection unit housing 141 through the first dust collection flow path 147.

The second dust collection flow path 148 may connect the internal space of the dust collection unit housing 141 with the internal space of the dust collection motor housing 146. The second dust collection flow path 148 may be formed along a direction intersecting the vertical direction. For example, the second dust collection flow path 148 may be formed substantially in the horizontal direction.

In this case, in the present disclosure, the first dust collection flow path 147 and the second dust collection flow path 148 may be formed at different heights. That is, the first dust collection flow path 147 and the second dust collection flow path 148 may be arranged in a stacked structure. At least a portion of the first dust collection flow path 147 may be disposed above the second dust collection flow path 148.

With this configuration, the overall height can be reduced by arranging a plurality of flow paths substantially in the horizontal direction, while simultaneously minimizing the width in the left-right direction and the overall volume of the robot cleaner station 100 by stacking them.

### Mop Washing Unit

Hereinafter, a mop washing unit 160 of a robot cleaner station 100 according to an embodiment of the present disclosure will be described.

The robot cleaner station 100 according to an embodiment of the present disclosure may include a mop washing unit 160. The mop washing unit 160 is configured to wash the mop 242 of the robot cleaner 200 coupled to the docking portion 120 by supplying washing water thereto, and to drain wastewater after washing the mop 242.

The mop washing unit 160 may include a washing water supply portion configured to mix a liquid containing detergent with purified water and discharge the mixture above a washing plate 122. The washing water supply portion may include a regulator 161, a mixing chamber 162, a detergent tank 163, a branch flow path 164, and washing water nozzles 165.

In this case, the detergent tank 163 and a wastewater tank 166 may be accommodated in a space formed between an inner wall 124 and an outer wall 111 of a housing. The detergent tank 163 may be disposed at a lower side of the space between the inner wall 124 and the outer wall 111, and the wastewater tank 166 may be disposed above the detergent tank 163.

A water supply pipe of a kitchen cabinet 2 is connected to the regulator 161 so that a flow rate supplied from the water supply pipe can be regulated. Additionally, a portion of the purified water that has passed through the regulator 161 is supplied to a water tank 230 of the robot cleaner 200 through a water supply nozzle 123c, and the remainder may be supplied to the mixing chamber 162.

Further, the liquid containing detergent stored in the detergent tank 163 may be supplied to the mixing chamber 162 through a flow force of a pump. A detailed structure of the detergent tank 163 will be described later.

The mixing chamber 162 defines a space in which the liquid containing detergent and the purified water are respectively introduced and mixed, and is configured to discharge washing water in which the detergent and the purified water are mixed. Such a mixing chamber 162 may include a purified water inlet 162a, a detergent inlet 162b, and a branch flow path connector 162c.

The mixing chamber 162 is provided inside the housing 110 and may be disposed rearward of the docking portion 120. In this case, a flow path 161a through which purified water is introduced from the regulator 161 may be connected to the purified water inlet 162a. Additionally, a flow path 163a through which the liquid containing detergent is introduced from the detergent tank 163 may be connected to the detergent inlet 162b. Accordingly, the regulator 161 and the pump of the detergent tank 163 may operate for a predetermined time to flow a preset amount of purified water and detergent into the mixing chamber 162.

Meanwhile, the branch flow path connector 162c may be connected to a branch flow path 164. The branch flow path 164 may supply the washing water, in which the purified water and detergent are mixed, to each of a pair of washing water nozzles 165.

The branch flow path 164 may be formed in a shape in which one pipe is branched into two. In this case, one branched end is connected to one of the pair of washing water nozzles 165, and the other branched end may be connected to the other of the pair of washing water nozzles 165.

The washing water nozzles 165 may be provided as a pair disposed to be spaced apart from each other. In this case, the pair of washing water nozzles 165 may be disposed at positions symmetrical to each other.

The washing water nozzles 165 are connected to the branch flow path 164 so that washing water is introduced therein and can be discharged to the washing plate 122. The washing water nozzles 165 may discharge the washing water onto an upper surface of the washing plate 122 through a washing water discharge port 165a. The washing water discharge port 165a may be opened in a direction facing an upper surface of the mop 242 seated on the washing plate 122. More specifically, the washing water discharge port 165a formed in the washing water nozzle 165 may discharge the washing water toward the washing protrusions 122a of the washing plate 122.

The washing water nozzle 165 may be provided on a nozzle installation wall connected to the coupling wall 123. The washing water nozzle 165 may be positioned higher than an uppermost end of the washing plate 122 to allow for detachability of the washing plate 122. Accordingly, when the washing plate 122 is detached or the drawer 190 is withdrawn, the washing plate 122 and the washing tub 128 do not collide with the washing water nozzle 165, and a washing water discharge space may be provided between the nozzle installation wall and the washing plate 122.

Further, the washing water nozzle 165 may be disposed at a position spaced vertically upward from a position spaced apart from a center of the washing protrusion portion 122a in a width direction. Specifically, assuming that a rotation direction of the mop 242 during a washing process of the mop 242 is a first direction, the washing water nozzle 165 may be disposed at a position spaced apart from the center of the washing protrusion portion 122a in a second direction in the width direction. With this configuration, the washing water can flow along the center of the washing protrusion portion 122a in the width direction.

The detergent tank 163 includes a detergent tank body 163a, a handle 163b, and a detergent tank rail 163c.

The detergent tank body 163a may provide a space capable of storing a liquid containing detergent. For example, the detergent tank body 163a may be formed in a box shape with an open top.

A handle 163b may be provided at a front of the detergent tank body 163a. The handle 163b may be provided to be graspable by a user. For example, the handle 163b may be recessed rearward from a front surface of the detergent tank body 163a.

With this configuration, when the user grasps and pulls the handle 163b forward, the detergent tank body 163a is pulled forward together and can be withdrawn. Accordingly, according to the present disclosure, the user can easily pull the detergent tank 163 forward and subsequently supply detergent.

A detergent tank rail 163c may be formed on the detergent tank body 163a. The detergent tank rail 163c may guide the movement of the detergent tank body 163a.

For example, the detergent tank rail 163c may be formed in a shape of a groove or a rib along a front-rear direction on side surfaces of the detergent tank body 163a in the left-right direction.

With such a configuration, when the user couples the detergent tank 163 to the housing 110, it can be coupled to a designated position, and leakage of the washing water can be prevented.

Meanwhile, although not shown, a rail may be formed on the housing 110 corresponding to the detergent tank rail 163c. The rail may be formed to correspond to a shape and position of the detergent tank rail 163c.

The wastewater tank 166 may provide a space in which wastewater used for washing the mop 242 is stored. After the washing of the mop 242 is completed, the washing water discharged onto the upper surface of the washing plate 122 may descend along an inclination of the washing plate 122 and be drained through the passage hole 122b. The washing water that has passed through the passage hole 122b accumulates in the washing tub 128. In addition, the washing water accumulated in the washing tub 128 may be introduced into a wastewater suction flow path 166b through a wastewater inlet 166a, and then flow into the wastewater tank 166 through the wastewater suction flow path 166b. That is, the liquid that has passed through the washing plate 122 may flow along the washing tub 128 and be discharged through the wastewater inlet 166a.

Meanwhile, the wastewater suction flow path 166b is formed in a wastewater suction pipe, and a wastewater inlet 166a is formed at one end of the wastewater suction pipe, while the other end of the wastewater suction pipe communicates with the wastewater tank 166. In this case, the wastewater suction pipe may be disposed to pass through a lower side of an external air supply module 171. That is, the wastewater suction flow path 166b may be disposed at the lower side of the external air supply module 171. Additionally, the wastewater suction flow path 166b may be disposed below an air supply flow path 171a.

The washing water stored in the wastewater tank 166 may be drained to the drain pipe 25 of the kitchen cabinet 2 through a wastewater discharge flow path 167. One end of the wastewater discharge flow path 167 may be connected to the wastewater tank 166, and the other end may be connected to the drain pipe 25. In this case, the washing water stored in the wastewater tank 166 may flow through the wastewater discharge flow path 167 by a centrifugal pump (not shown) to be drained to the drain pipe 25.

The wastewater discharge flow path 167 connected to the wastewater tank 166 may be connected to an upstream portion 25b relative to a U-trap 25a of the drain pipe 25 of the kitchen cabinet 2. This is because, if the wastewater discharge flow path 167 is connected to a downstream portion 25c relative to the U-trap 25a of the drain pipe 25, malodors or fluids inside the drain pipe 25 may flow back into the wastewater discharge flow path 167.

In addition, the mop washing unit 160 may include a check valve (not shown). The check valve may prevent the fluid inside the drain pipe 25 from flowing back into the wastewater discharge flow path 167. The check valve may be provided at the other end of the wastewater discharge flow path 167 connected to the drain pipe 25.

### Mop Drying Unit

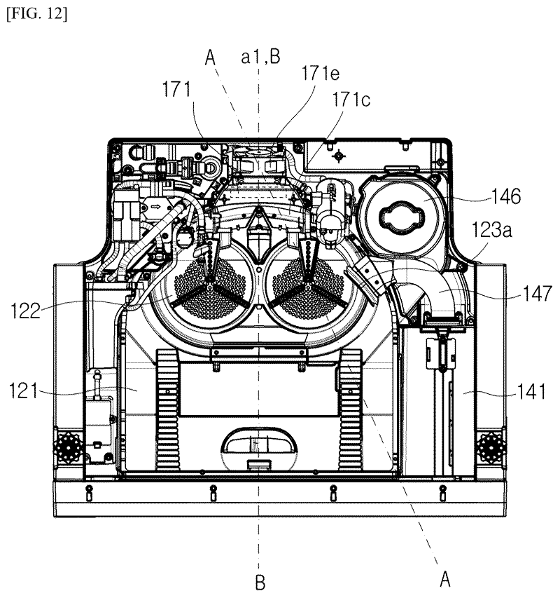

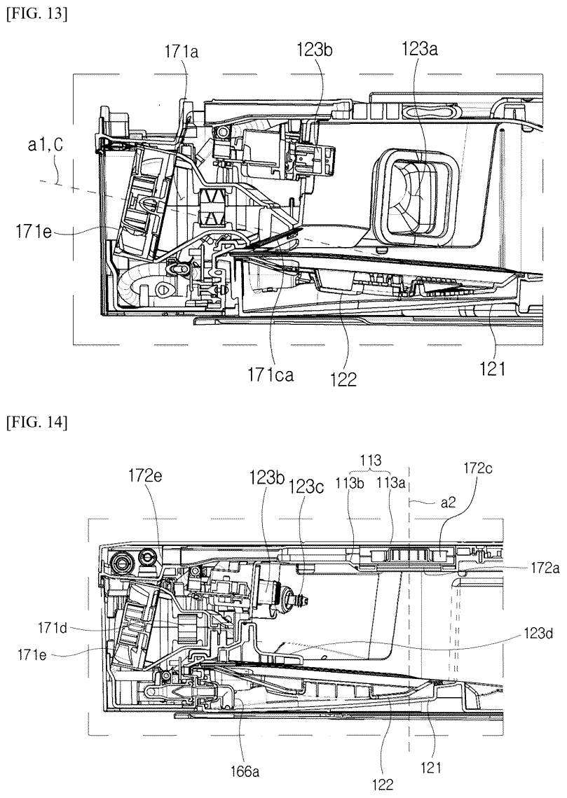

FIG. 12 is a plan view for explaining a mop drying unit of a robot cleaner station according to an embodiment of the present disclosure. FIG. 13 is a cross-sectional view taken along line A-A of FIG. 12. FIG. 14 is a cross-sectional view taken along line B-B of FIG. 12.

Referring to FIGS. 12 to 14, the robot cleaner station 100 according to an embodiment of the present disclosure may include a mop drying unit 170. In this case, the mop drying unit 170 may dry the mop 242 of the robot cleaner 200 washed by the mop washing unit 160 or a mop 242 in a wet state after a wet cleaning operation is completed.

The mop drying unit 170 may include an external air supply module 171 and an air discharge portion 172.

The external air supply module 171 may heat air and supply the heated air to the accommodation space S. The external air supply module 171 may include an air supply flow path 171a, an external air inlet 171b, an air discharge portion 171c, a heater 171d, and a blower fan 171e.

An air supply flow path 171a is formed in the external air supply module 171. The air supply flow path 171a may allow air to flow to the air discharge portion 171c.

The air supply flow path 171a may discharge air to the accommodation space S. The air supply flow path 171a may connect air introduced into the housing 110 to the accommodation space S. The other side of the air supply flow path 171a may communicate with the accommodation space S through the air discharge portion 171c. The air supply flow path 171a may discharge air introduced through gaps in a front surface, a lower surface, or a rear surface of the housing 110 to the accommodation space S.

A blower fan 171e and a heater 171d may be sequentially disposed on the air supply flow path 171a. A height of the air supply flow path 171a may decrease from the blower fan 171e toward the heater 171d.

Through this configuration, a flow velocity of air passing through the air supply flow path 171a may be increased. Accordingly, heating efficiency of the heater 171d through the heater 171d can be increased.

The air supply flow path 171a may be branched into two flow paths. The air supply flow path 171a may be branched toward both sides based on a blower fan axis a1 and each may be connected to the accommodation space S. The air supply flow path 171a may be branched into two flow paths and connected to a pair of air discharge ports 171ca. The air supply flow path 171a may be branched into two flow paths forward of the heater 171d. Accordingly, air can be independently supplied to each of a pair of mops 242 disposed symmetrically in a left-right direction on a lower side of the robot cleaner 200.

The external air inlet 171b may be formed on the rear surface 111b of the housing 110. Air outside the housing 110 may be introduced into the air supply flow path 171a through the external air inlet 171b.

As another example, the housing 110 may not include a separate configuration for introducing external air. That is, air may be introduced through gaps formed in the front surface, the lower surface, or the rear surface of the housing 110. Accordingly, air outside the housing 110 can be introduced into the housing 110.

At least a portion of the air discharge portion 171c may be disposed above the washing plate 122. The air discharge portion 171c may be opened in a direction facing the washing plate 122. A pair of air discharge portions 171c may be provided in a state of being opened downward. The pair of air discharge portions 171c may be formed symmetrically in a left-right direction based on a virtual shaft axis a1 extending from a rotation shaft of a blower fan 171e.

The air discharge portion 171c may discharge air that has passed through the air supply flow path 171a. The air discharge portion 171c may be disposed forward of the heater 171d. The air discharge portion 171c may discharge air heated by the heater 171d into the accommodation space S. The air heated by the heater 171d may be branched to the left and right and discharged through a pair of air discharge ports 171ca.

Through this configuration, the pair of air discharge portions 171c can dry the mops 242 disposed symmetrically in the left-right direction on the lower side of the robot cleaner 200. In addition, it is possible to prevent heat from being intensively applied to a specific area, thereby improving the drying efficiency of the mops 242.

In particular, the air discharge portion 171c may be provided in a form inclined downward toward the front of the robot cleaner station 100. That is, the air discharge portion 171c may be provided in a form inclined downward as it moves away from the heater 171d. Accordingly, an end of the air discharge portion 171c from which air is discharged may be inclined at a predetermined angle with respect to the ground. In this case, the angle may be 90 degrees or less. Therefore, the air discharge portion 171c can discharge air along a direction intersecting a direction in which the flow guide surface 122c is formed.

For example, an air discharge port 171ca may be formed in the air discharge portion 171c. The air discharge port 171ca may refer to an open part of the air discharge portion 171c. The air discharge port 171ca may discharge air toward the washing plate 122. In a state where the mop 242 is seated on the washing plate 122, the air discharge portion 171c may be opened toward an upper surface of the mop 242. Therefore, the air discharge portion 171c is positioned adjacent to the mop 242 and opened downward, so that air discharged from the air discharge portion 171c can flow toward the mop 242.

Meanwhile, the air discharge port 171ca may be penetrated by a virtual plane C including the blower fan axis a1 and a virtual line connecting left and right points forming a maximum width of the blower fan 171e. According to an embodiment of the present disclosure, the blower fan 171e may be disposed in an inclined state. More specifically, the blower fan 171e may be disposed to be inclined such that a surface from which air is discharged faces the ground. In addition, the air discharge portion 171c may be provided in a form inclined downward as it moves away from the heater 171d. Therefore, the plane C including the blower fan axis a1 may be formed to penetrate the air discharge port 171ca that is opened downward.

By this configuration, a flow path through which the air discharged from the blower fan 171e reaches the mop 242 through the air discharge port 171ca can be shortened. In addition, the velocity of the heated air transmitted to the mop 242 increases, so that drying efficiency can be improved.

Meanwhile, a grille for guiding a discharge direction of air may be provided in the air discharge portion 171c. Through this, it is possible to prevent the heated air from being intensively discharged to a specific position.

The blower fan 171e is disposed on the air supply flow path 171a and is configured to blow air toward the accommodation space S. The blower fan 171e may provide a flow force to air introduced through gaps of the housing 110.

The blower fan 171e may cause air to flow toward the air discharge portion 171c. When the blower fan 171e is driven, the air is heated by the heater 171d and can be discharged into the accommodation space S through the air discharge portion 171c.

The blower fan 171e may be disposed such that a surface from which air is discharged faces the accommodation space S. That is, the blower fan 171e may be configured as an axial fan. An air discharge direction of the blower fan 171e may be parallel to the rotation shaft of the shaft. An air suction direction of the blower fan 171e may be parallel to the air discharge direction.

Through this configuration, the flow path can be simplified by aligning the suction direction and the discharge direction of the air flow. In addition, the same air volume can be provided even at a relatively low rotation speed. Therefore, compared to a case where the blower fan 171e is configured as a centrifugal fan, a smaller-sized blower fan 171e can be used. Accordingly, the space occupied by the blower fan 171e is minimized, and the number of required components can be reduced.

The blower fan 171e may be disposed between the rear surface 111b of the housing 110 and the heater 171d. The blower fan 171e may be arranged to have a predetermined inclination with respect to the rear surface 111b. The blower fan 171e may be inclined such that a surface from which air is discharged faces the ground.

In detail, a virtual blower fan axis a1 extending from the rotation shaft of the blower fan 171e may form a predetermined slope with the ground. The blower fan axis a1 may form a predetermined slope with the rear surface 111b. The blower fan axis a1 may penetrate the heater 171d.

At least a portion of the blower fan 171e may be spaced apart from the rear surface 111b. The blower fan 171e may be disposed at a predetermined angle with respect to the rear surface 111b. Accordingly, a distance between an uppermost end of the blower fan 171e and the rear surface 111b may be greater than a distance between a lowermost end of the blower fan 171e and the rear surface 111b.

Meanwhile, when a maximum clearance between the blower fan 171e and the rear surface 111b is secured to a certain level or more, smooth air flow can be established. That is, degradation in Fan Motor Control (FMC) performance can be minimized under the maximum output condition of the heater. In particular, when the distance between the blower fan 171e and the rear surface 111b is 30 mm, there is an effect that the FMC performance degradation rate is maintained at −1.47%.

If the maximum clearance between the blower fan 171e and the rear surface 111b is set to less than 25 mm, the air flow is not smoothly established, and thus there is a high possibility that the air around the heater 171d stagnates. Accordingly, the temperature of the heater 171d may rise to 112° C. or higher, and the temperature of the surface where air is discharged from the blower fan 171e may also increase to 30° C. or higher, thereby increasing the load on the blower fan 171e and causing a risk of overheating. In addition, the temperature of the air discharge port 171ca may rise to 73° C. or higher, increasing the possibility that air discharge will not be smooth.

If the maximum clearance between the blower fan 171e and the rear surface 111b exceeds 35 mm, air discharge may be smooth, but the air suction efficiency of the blower fan 171e may decrease due to the excessive distance from the rear surface 111b. Specifically, as the air flow rate through the blower fan 171e excessively increases, the heat transfer efficiency through the heater 171d may decrease. Furthermore, if the interval between the blower fan 171e and the rear surface 111b becomes excessively wide, it becomes difficult to efficiently utilize the internal space of the housing 110, and the volume occupied by the mop drying unit 170 may increase.

Therefore, in the robot cleaner station 100 according to an embodiment of the present disclosure, the maximum clearance between the blower fan 171e and the rear surface 111b may be set to be 25 mm or more and 35 mm or less. Through this, the stability of the air flow can be secured, the temperature of the heater 171d can be maintained at an appropriate level, and further, the performance of the blower fan 171e can be optimized.

The heater 171d may heat air. The heater 171d may heat air flowing through the air supply flow path 171a. The heater 171d may heat air discharged through the air discharge portion 171c. The heater 171d may be disposed forward of the blower fan 171e.

The heater 171d may include a heater housing and a heating element. In this case, the heater housing may be disposed on the air supply flow path 171a, and a space for accommodating the heating element may be provided therein. In addition, the heating element may heat air introduced into the heater housing. Accordingly, the air heated by the heating element is discharged into the accommodation space S through the air discharge portion 171c to dry the wet mop 242.

Air heated by the heat discharged from the external air supply module 171 may be discharged through the air discharge portion 172. At least a portion of the air discharge portion 172 may be disposed at an upper portion of the accommodation space S.

The air heated by the heat discharged from the external air supply module 171 may supply heat to the mop 242 of the robot cleaner 200. Accordingly, moisture absorbed and remaining in the mop 242 may absorb heat from the air and be vaporized. The moisture vaporized in this manner may flow within the accommodation space S. Therefore, the air within the accommodation space S may contain the vaporized moisture, and the humidity within the accommodation space S may increase (hereinafter, the air containing the vaporized moisture in the accommodation space S may be referred to as “wet steam”).

The air discharge portion 172 may discharge the air within the accommodation space S to the outside. Specifically, at least a portion of the air discharge portion 172 may be disposed on the upper cover 113, and the upper cover 113 may cover the upper portion of the accommodation space S.

The air heated by the heat discharged from the external air supply module 171 is in a state where the humidity is increased by vaporizing the moisture of the mop 242. Therefore, when the robot cleaner station 100 is disposed at the lower portion of the kitchen cabinet 2, if the wet steam comes into contact with various components of the kitchen cabinet 2, such as the baseboard 26, it adversely affects those components.

At this time, in the present embodiment, the upper cover 113 covers the upper portion of the accommodation space S and the door 131 covers the front of the accommodation space S. Thus, the upper cover 113, together with the door 131, prevents the wet steam in the accommodation space S from escaping to the outside, thereby preventing the kitchen cabinet 2 from coming into contact with the wet steam.

The air discharge portion 172 may include an air intake 172a, an air discharge duct 172b, and an exhaust fan 172c.

An air intake 172a may communicate with the accommodation space S. The air intake 172a may be disposed above the accommodation space S. Wet steam in the accommodation space S may be discharged through the air intake 172a. Air within the accommodation space S may be suctioned through the air intake 172a.

The air intake 172a may be disposed at a position higher than the air discharge port relative to the ground than the robot cleaner 200 in a state where the robot cleaner 200 is docked in the docking portion 120. Through this, the efficiency of suctioning steam that rises by convection during the drying of the mop can be increased.

For example, the air intake 172a may be formed on the upper cover 113. In this case, the upper cover 113 may be formed in a shape in which two or more plates are overlapped, and the air intake 172a may be formed on an inner cover 113b, which is the lowermost plate among them. A flow path communicating with the air intake 172a may be formed between the inner cover 113b and an outer cover 113a to constitute an air discharge duct 172b.

In addition, the air intake 172a may be disposed at a position higher than the air discharge port relative to the ground than an air discharge port 171ca.

As another example, the air intake 172a may be formed on an air discharge duct 172b in a circular or rectangular pipe shape, and the air discharge duct 172b may be coupled to the upper cover 113.

With this configuration, when the upper cover 113 is separated, the air discharge duct 172b can be separated together with the upper cover 113. This provides an advantage in that an operator can remove even the air discharge duct 172b through a simple operation of lifting the upper cover 113 when it is necessary to open the upper portion of the robot cleaner station 100 for reasons such as repair.

The air intake 172a may be formed in a hole shape on the upper cover 113. The air intake 172a may be in a circular hole shape. An exhaust fan housing may be directly coupled to the corresponding hole portion of the air intake 172a. Through this, air introduced through the air intake 172a can immediately flow into the exhaust fan housing. Air suctioned through the air intake 172a may be introduced into an exhaust fan 172c. A distance from an air discharge portion 171c to the air intake 172a may be greater than a distance from the air discharge portion 171c to the mop 242. This is to prevent energy from being wasted due to the heated air discharged from the air discharge portion 171c being immediately suctioned into the air intake 172a without being sufficiently supplied to the mop 242.

Furthermore, the air intake 172a may be disposed closer to the door 131 than the air discharge portion 171c. By disposing the air intake 172a at an upper front portion of the accommodation space S, a range of a space through which heat discharged from the air discharge portion 171c flows is widened, thereby improving the drying efficiency of the mop 242. Therefore, heat discharged through the air discharge portion 171c can dry the mop 242 of the robot cleaner 200 while flowing forward, and then be discharged through the air intake 172a.

In addition, the air intake 172a may be disposed above a path along which the robot cleaner 200 moves within the housing 110. Through this, it is possible to prevent condensation from occurring on a wall inside the housing 110.

For example, at least a portion of the air intake 172a may be disposed vertically above a position where a horizontal width of the robot cleaner 200 is maximum in a state where the robot cleaner 200 is docked in the docking portion 120. That is, at least a portion of the air intake 172a may be disposed above a position where a gap between the robot cleaner 200 and a pair of inner walls 124 is narrowest. In this case, at least a portion of the air intake 172a may be disposed forward of the washing plate 122.

Through this, steam generated during a drying process of the mop 242 can be prevented from flowing toward a front of the robot cleaner station 100, and a malfunction caused by moisture penetrating into a sensor disposed at a front of the robot cleaner 200 can be prevented.

The air discharge duct 172b may connect the exhaust fan 172c and an air outlet 172e to communicate with the drain pipe 25 of the kitchen cabinet 2. The air discharge duct 172b may guide wet steam discharged through the air intake 172a to the drain pipe 25.

One side of the air discharge duct 172b may be connected to the air intake 172a, and the other side may be connected to the air outlet 172e. An exhaust fan 172c may be disposed on the air discharge duct 172b. An air discharge flow path communicating with the air intake 172a may be formed inside the air discharge duct 172b.

The exhaust fan 172c may cause air in the accommodation space S to flow toward the air intake 172a. A flow of air from the air intake 172a toward the drain pipe 25 can be generated. The exhaust fan 172c may generate an air flow so that wet steam in the accommodation space S is suctioned into the air intake 172a and then discharged to the outside through the air discharge duct 172b.

The exhaust fan 172c may include an exhaust fan housing, a shaft, a fan motor, and an impeller. A flow path may be formed inside the exhaust fan housing so as to communicate with the air discharge duct 172b. When the exhaust fan motor is operated and the exhaust fan impeller rotates, air in the accommodation space S or the housing 110 is introduced into the air discharge duct 172b, passes through the interior of the exhaust fan housing, and can be discharged to the air outlet 172e.

Meanwhile, in the present embodiment, the exhaust fan 172c may be disposed above the path along which the robot cleaner 200 moves within the housing 110. For example, the exhaust fan 172c may be disposed on the upper cover 113. The exhaust fan housing may be disposed between an outer cover 113a and an inner cover 113b included in the upper cover 113.

A virtual exhaust fan axis a2 extending from a rotation shaft of a shaft included in the exhaust fan 172c may be disposed perpendicular to the ground. That is, an air suction direction of the exhaust fan 172c may be perpendicular to the ground.

Meanwhile, in the present embodiment, the exhaust fan 172c may be configured as a centrifugal fan. An air discharge direction of the exhaust fan 172c may be perpendicular to the rotation shaft of the shaft. The air suction direction of the exhaust fan 172c may be perpendicular to the air discharge direction. When the exhaust fan 172c is driven, air in the accommodation space S can be introduced into the air intake 172a. The air introduced into the air intake 172a can be exhausted to the drain pipe 25.

In this case, the air outlet 172e may be formed in a shape that is open toward the rear of the housing 110. Condensation generated by wet steam discharged through the air outlet 172e may collect along an inclined surface formed on a fitting coupling portion 114 of the housing 110. The air discharged from the air outlet 172e may diffuse into the external air.

### Drawer

When a charging dock for a robot cleaner is disposed at a lower portion of a kitchen cabinet, exposure to the outside is minimized, which provides an aesthetic effect. However, if the robot cleaner or the charging dock malfunctions while the robot cleaner is inside the lower portion of the kitchen cabinet, there is a limitation in that it may be difficult for a user to pull it out for repair. To address this, a drawer 190 may be added to the robot cleaner station 100 in the present disclosure.

The robot cleaner station 100 according to an embodiment of the present disclosure may further include a drawer 190 that is withdrawn from the housing 110.

The drawer 190 may be moved relative to the housing 110. For example, the housing 110 is fixedly coupled to the kitchen cabinet 2, and the drawer 190 may be withdrawn forward from the housing 110.

At this time, the drawer 190 may be withdrawn in a state in which the docking portion 120 is provided therein. With this configuration, when the drawer 190 is withdrawn, the docking portion 120 and/or the robot cleaner 200 may be withdrawn from the kitchen cabinet 2 to the outside.

In this case, if the drawer 190 is withdrawn from the housing 110 while the door 131 closes the entrance 127, the upper cover 113 may be exposed to the outside. At this time, when the upper cover 113 is disassembled, the robot cleaner 200 may be exposed to the outside.

Therefore, according to the present embodiment, when maintenance such as repair or cleaning of the robot cleaner station 100 is required, the user can easily withdraw the docking portion 120 and/or the robot cleaner 200 through the drawer 190 to expose internal components of the robot cleaner station 100 or the robot cleaner 200.

Meanwhile, the drawer 190 according to an embodiment of the present disclosure may be withdrawn in a state in which the dust collection unit 140 is provided therein. In this case, a withdrawal direction of the drawer 190 may be parallel to a withdrawal direction of the dust bag drawer 144.

In addition, the drawer 190 according to an embodiment of the present disclosure may be withdrawn together with the mop washing unit 160. Specifically, the drawer 190 may be withdrawn together with the detergent tank 163. In this case, the withdrawal direction of the drawer 190 may be parallel to a withdrawal direction of the detergent tank 163.

With such a configuration, the robot cleaner station 100 according to an embodiment of the present disclosure may be provided such that the withdrawal directions of the drawer 190, the dust bag drawer 144, and the detergent tank 163 are all parallel to each other.

Accordingly, the user can easily recognize the withdrawal directions of the components of the robot cleaner station 100 of the present disclosure, and can easily withdraw them for repair and maintenance.

The drawer 190 includes a drawer sidewall 191, a fitting portion 192, and a drawer rail 193.

The drawer sidewall 191 is provided to be relatively movable with respect to an outer wall surface of the housing 110. For example, a pair of drawer sidewalls 191 may be disposed to face a pair of outer walls of the housing 110.

In this case, the pair of drawer sidewalls 191 may be disposed further inside the robot cleaner station 100 than the pair of outer walls of the housing 110. That is, the pair of drawer sidewalls 191 may be disposed closer to the docking portion 120 than the pair of outer walls of the housing 110.

Meanwhile, a dust collection unit 140 and/or a mop washing unit 160 may be disposed between the drawer sidewall 191 and the docking portion 120.

With such a configuration, there is an effect that the dust collection unit 140 and the mop washing unit 160 can be disposed by utilizing a minimum horizontal space.

The drawer rail 193 is disposed on the drawer sidewall 191 and can guide the movement of the drawer sidewall 191. The drawer rail 193 is fixedly coupled to or integrally formed with the drawer sidewall 191 and is coupled with a rail installed on the outer wall 111 of the housing 110 to guide a movement path of the drawer sidewall 191. Meanwhile, although it is described in the present disclosure that the drawer 190 and the housing 110 are provided with rails, the present disclosure is not necessarily limited to the form of rails, and may include all forms such as rollers, guide grooves, or guide ribs that can replace the rails.

### Control Configuration

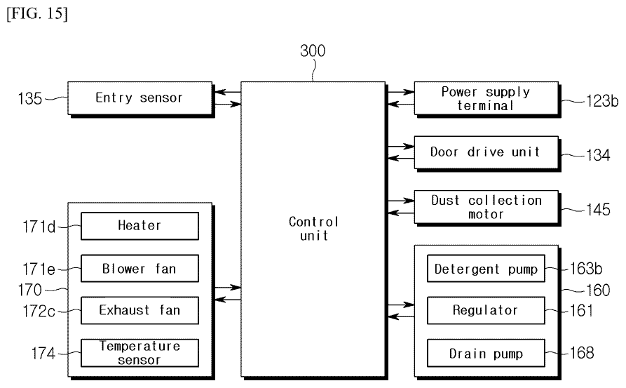

FIG. 15 illustrates a block diagram for explaining a control configuration in a cleaner station according to an embodiment of the present disclosure.

The control configuration of the robot cleaner station 100 of the present disclosure will be described as follows with reference to FIG. 15.

The cleaner station 100 according to an embodiment of the present disclosure further includes a controller 300 configured to control the docking portion 120, the dust collection motor 145, the mop washing unit 160, and the mop drying unit 170.

The controller 300 may be composed of a printed circuit board (PCB) and elements mounted on the PCB.

The controller 300 may receive a signal from an entry sensor 135 and control a door driving unit 134.

The controller 300 may detect an approach of the robot cleaner 200 and control the door driving unit 134 to rotate the door 131. Specifically, the controller 300 may detect whether the robot cleaner 200 enters through the entry sensor 135. When a distance between the robot cleaner 200 and the door 131 is closer than a preset distance, the entrance 127 may be opened by rotating the door 131. In addition, when the robot cleaner 200 is coupled to the docking portion 120, the controller 300 may close the entrance 127 by rotating the door 131.

When power is supplied from the power supply terminal 123b to a battery of the robot cleaner 200, the controller 300 may determine that the robot cleaner 200 is coupled to the docking portion 120.

The controller 300 may drive the dust collection motor 145 to suction dust inside a dust bin 220 of the robot cleaner 200.

Meanwhile, the robot cleaner station 100 according to an embodiment of the present disclosure may include a memory (not shown). The memory may include various data for driving and operating the robot cleaner station 100.

In the meantime, the robot cleaner station 100 according to an embodiment of the present disclosure may include a communication unit (not shown). The communication unit may support wireless communication with other devices existing outside the robot cleaner station 100, including the robot cleaner 200 or a terminal (not shown). As a wireless communication module for supporting wireless communication, a short-range communication module or a long-range communication module may be provided.

Short-range communication may be, for example, Bluetooth communication, Near Field Communication (NFC), or the like.

Long-range communication may include, for example, Wireless LAN (WLAN), Digital Living Network Alliance (DLNA), Wireless Broadband (Wibro), World Interoperability for Microwave Access (Wimax), Global System for Mobile communication (GSM), Code Division Multi Access (CDMA), Code Division Multi Access 2000 (CDMA2000), Enhanced Voice-Data Optimized or Enhanced Voice-Data Only (EV-DO), Wideband CDMA (WCDMA), High Speed Downlink Packet Access (HSDPA), High Speed Uplink Packet Access (HSUPA), IEEE 802.16, Long Term Evolution (LTE), Long Term Evolution-Advanced (LTE-A), Wireless Mobile Broadband Service (WMBS), Bluetooth Low Energy (BLE), Zigbee, Radio Frequency (RF), Long Range (LoRa), and the like.

The controller 300 may control the mop washing unit 160.

Specifically, the controller 300 may control a detergent pump 163b. The controller 300 may operate the detergent pump 163b to discharge detergent stored in the detergent tank 163 toward the mop 242.

In addition, the controller 300 may control the regulator 161. The controller 300 may operate the regulator 161 to adjust an amount of purified water discharged toward the mop 242.

Furthermore, the controller 300 may control a drain pump 168. The controller 300 may operate the drain pump 168 to drain wastewater after washing the mop 242.

The controller 300 may control the mop drying unit 170.

Specifically, the controller 300 may control the heater 171d. The controller 300 may operate the heater 171d to heat air discharged toward the mop 242.

Additionally, the controller 300 may control the blower fan 171e. The controller 300 may operate the blower fan 171e to discharge air toward the mop 242.

Moreover, the controller 300 may control the exhaust fan 172c. The controller 300 may operate the exhaust fan 172c to discharge air, after drying the mop 242, to the outside.

In addition, the controller 300 may receive a signal from a temperature sensor 174. The controller 300 may measure a temperature of air within the housing 110 based on temperature information received from the temperature sensor 174. Further, the controller 300 may control an operation of the heater 171d based on the temperature information received from the temperature sensor 174 to sterilize bacteria present on the mop 242.

While the present disclosure has been described in detail through specific embodiments, these are for illustrative purposes only, and the present disclosure is not limited thereto. It is apparent that modifications or improvements can be made by those skilled in the art within the spirit and technical scope of the present disclosure.

All simple modifications or changes of the present disclosure fall within the scope of the present disclosure, and the specific scope of protection of the present disclosure will be made clear by the appended claims.

### DESCRIPTION OF NUMERAL REFERENCES

1: Cleaner System 2: Kitchen Cabinet
100: Robot cleaner station 110: Housing
120: Docking portion 122: Washing plate
128: Washing tub 130: Door unit
131: Door 140: Dust collection unit
141: Dust collection unit housing 144: Dust bag drawer
145: Dust collection motor 160: Mop washing unit
170: Mop drying unit 171: External air supply module
171a: Air supply flow path 171c: Air discharge portion
171ca: Air discharge port 171d: Heater
171e: Blower fan 172: Air discharge portion
172a: Air intake 172b: Air discharge duct
172c: Exhaust fan 172e: Air outlet
190: Drawer 200: Robot cleaner
300: Controller

What is claimed is:

1. A robot cleaner station comprising:
a housing including an upper cover;
a base accommodated inside the housing and disposed below a robot cleaner;
an accommodation space formed between the base and the upper cover, wherein at least a portion of the robot cleaner is accommodated in the accommodation space; and
a mop drying unit configured to dry a mop of the robot cleaner,
wherein the mop drying unit includes a blower fan configured to provide a flow force to air discharged into the accommodation space, and
wherein the blower fan is disposed in the housing such that a surface from which air is discharged faces the accommodation space, and an imaginary axis extending from a rotation shaft of the blower fan forms a predetermined inclination with respect to the ground.

2. The robot cleaner station of claim 1, wherein the housing includes:
an entrance through which the robot cleaner enters and exits; and
a rear surface disposed in a direction opposite to the entrance,
wherein at least a portion of the blower fan is spaced apart from the rear surface.

3. The robot cleaner station of claim 1, wherein the mop drying unit further includes a heater disposed forward of the blower fan and configured to heat air, and
wherein the blower fan axis penetrates the heater.

4. The robot cleaner station of claim 3, wherein the mop drying unit includes an air discharge portion disposed forward of the heater and having an air discharge port formed therein to discharge heated air toward the accommodation space, and
wherein the air discharge portion is inclined downward as a distance from the heater increases.

5. The robot cleaner station of claim 4, wherein a pair of the air discharge portions are formed symmetrically in a left-right direction with respect to the blower fan axis.

6. The robot cleaner station of claim 4, wherein the mop drying unit further includes an air supply flow path connecting air introduced into the housing to the accommodation space, and
wherein the air supply flow path is branched toward both sides with respect to the blower fan axis and connected to the accommodation space.

7. The robot cleaner station of claim 4, wherein a virtual plane including the blower fan axis and a virtual line connecting left and right points forming a maximum width of the blower fan penetrates the air discharge port.

8. The robot cleaner station of claim 3, wherein the mop drying unit further includes an air supply flow path connecting an outside of the housing to the accommodation space, the blower fan and the heater being disposed inside the air supply flow path, and
wherein a height of the air supply flow path decreases from the blower fan toward the heater.

9. The robot cleaner station of claim 1, wherein the mop drying unit includes an air discharge portion configured to discharge air within the accommodation space to an outside,
wherein the air discharge portion includes:
an air intake communicating with the accommodation space to suction air; and
an exhaust fan configured to cause the air within the accommodation space to flow toward the air intake, and
wherein the exhaust fan is disposed such that a virtual exhaust fan axis extending from a rotation shaft of the exhaust fan is perpendicular to the ground.

10. The robot cleaner station of claim 9, wherein the exhaust fan is disposed above a path along which the robot cleaner moves within the housing.

11. The robot cleaner station of claim 9, wherein the exhaust fan is disposed on the upper cover.

12. The robot cleaner station of claim 9, wherein the mop drying unit includes:
a heater disposed forward of the blower fan and configured to heat air; and
an air discharge port disposed forward of the heater and configured to discharge heated air toward the accommodation space,
wherein the air intake is disposed at a position higher than the air discharge port relative to the ground than the air discharge port.

13. The robot cleaner station of claim 12, wherein a distance from the air discharge port to the air intake is greater than a distance from the air discharge port to the mop.

14. The robot cleaner station of claim 2, wherein a distance between an uppermost end of the blower fan and the rear surface is greater than a distance between a lowermost end of the blower fan and the rear surface.

15. The robot cleaner station of claim 2, wherein a maximum distance between the blower fan and the rear surface is 25 mm or more and 35 mm or less.
